(19) United States
(12) Patent Application Publication
(10) Pub. No.: US 2008/0240864 A1
(43) Pub. Date: Oct. 2, 2008

(54) Assembly, transportation and installation of deepwater windpower plant

(75) Inventor: Sidney I. Belinsky, West Palm Beach, FL (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: UPS Wind Management , LLC, Newton, MA (US)

(21) Appl. No.: 12/080,369

(22) Filed: Apr. 1, 2008

Related U.S. Application Data
(60) Provisional application No. 60/921,432, filed on Apr. 2, 2007.

(51) Int. Cl. E02D 5/74; F03D 9/00

(52) U.S. Cl. 405/223.1; 405/224; 405/205; 290/55

(57) ABSTRACT

A deepwater windpower plant (DWP) has a tension leg-type floating platform with an evacuable base for adjusting its buoyancy for installation at ocean depths ranging from 40 meters up to 1.5 kilometers and more. The DWP has a typical offshore wind turbine assembled close to shore which is then towed to a desired installation site on the ocean, and held in place by a gravity anchoring base (GAB), to which an evacuable portion or space of the DWP platform is anchored. The GAB has upwardly extending mooring tethers and a power cable which are brought to the ocean surface by attached buoys. The GAB is sunk to the ocean floor at the installation site under controlled conditions so that the GAB lands flat on the ocean floor. As the GAB sinks to the ocean floor, the mooring tethers and power cable are pulled to the surface by their respective buoys. The GAB is loaded with heavy ballast material that can be dropped from barges on the ocean surface into the upwardly open GAB below the barges.

### RELATED APPLICATIONS

This application claims priority from Provisional Patent Application No. 60/921,432 filed Apr. 2, 2007, the disclosure of which is incorporated herein by reference.

### FIELD OF THE INVENTION

This invention relates to harvesting wind energy in deep waters of the ocean far away from shore with floating wind turbines anchored to the sea bottom.

### BACKGROUND OF THE INVENTION

At the present time most of the wind turbines are located on land or offshore in shallow waters and rest on stable foundations. The recently increased use of wind turbines created backlash from populations living near them due to their noise, negative visual impact and the killing of birds. This is one of the reasons that prompted attempts to install wind turbines out of sight of populations living along coastlines. The other reason for the development of this new technology is that winds in open seas are more steady and stronger, which significantly improves the economic efficiency of wind turbines. A further reason is that oceans provide unlimited areas where wind can be harvested at a cost that is competitive with the cost of generating electricity with conventional power plants.

A major obstacle to achieving this goal is the existing technology of assembling modern wind turbines, which requires very large cranes that assemble windmills piece by piece and are not suited for assembling wind turbines in deep waters. In shallow waters, jack-up platforms are used as the base for crane operation, but they can only be deployed to limited depths of not more than about 60 meters. Use of floating cranes for assembling wind turbines in the open sea is impractical due to floating crane unavoidable rolling and pitching, which creates wide amplitudes of undesirable vertical and horizontal crane hook movements.

Newly appearing technology of harvesting wind energy in deep waters far away from shorelines is based on the use of floating structures anchored to the ocean floor and having minimum waterplane areas to withstand hurricane category wave actions. To avoid the use of cranes in open seas, the windmills have to be fully assembled in shallow water protective harbors, and they must then be moved in their upright positions to the points of installation. Since these deepwater installations have very small waterplane areas, they require special technology, which does not yet exist, to assemble them in shallow waters and to transport them safely through open seas to the point of installation. The most promising type of floating platform for wind turbines in deep waters is the tension leg platform with a gravity-type anchoring base. However, the weight of the gravity anchoring base (“GAB”) for modern wind turbines of 5 MW capacities can be as high as 10,000 tons in water, which creates problems for their manufacture, delivery and installation. There is further the problem of attaching and tensioning tethers to floating platforms, which presently requires special vessels and lengthy, complicated procedures.

The development of the new technology for locating and operating windmills in deep waters started only a few years ago, and as a result the available prior art is limited. The available prior art does not address the above-mentioned problems of assembling wind turbines in deep waters, transporting them in upright positions to their destinations, installing gravity anchors and attaching hold-down structures such as tethers to floating platforms of the windmills to secure them in place. The most relevant, recent U.S. patents include:
U.S. Pat. No. 7,156,586 B2 for a “Wind turbine with floating foundation” by Nim. This patent offers a new tension leg platform having three separate pontoons, but provides no information how the turbines are to be assembled, transported to a destination site and installed there.
U.S. Pat. No. 7,156,037 for a “Device for wind power station placed in deep water” by Borgen discloses two embodiments, one that consists of a tower attached to the ocean floor through a rigid rod, and the other which has the same tower, but it floats and is anchored to the ocean floor with several anchors. Both embodiments expect the tower to incline under wave and wind forces and therefore have means to keep the wind turbine perpendicular to the wind direction. Both have significant rigid ballasts for lowering the device center of gravity and water ballast, the volume of which can be changed to thereby provide the required counter moment to withstand wind and wave forces. Also, both embodiments have their wind turbines located on the leeward side of the tower to prevent propeller blades from smashing into the tower during platform inclinations. This patent does not indicate how the device is assembled, towed to the installation site and installed.
U.S. Pat. No. 7,075,189 for “Offshore wind turbine with multiple wind rotors and floating system” by Heronemus, et al. discloses a floating semi-submersible platform in the form of a vertically oriented tubular column with a very small waterplane area. It is moored to a single anchor point, which allows it to naturally weathervane under wind force. The above-water structure supports several wind turbines. To reduce the angle of inclination of the entire structure and prevent it from sinking under waves, a rigid ballast is located well below the ocean surface and further uses a water ballast for controlling the depth to which this system sinks. This patent does not explain how the windmill is assembled, delivered to its desired destination and installed.

A paper, “Design of a Semi-Submersible Platform for a 5 MW Wind Turbine”, presented to the AIAA Aerospace Sciences Meeting on 9-12 Jan. 2006 in Reno, Nev., uses a tension leg floating platform and a gravity anchoring base. In comparison to the above-mentioned patents, this paper provides for a stable positioning of the wind turbine without using any system that must operate continuously, which makes this design more reliable and practical. This paper also describes how the GAB can be manufactured and delivered to the designated point and how it might be installed. According to this technology, the anchoring base would be fully manufactured on the shore and is then moved to a floating dry-dock. The dry-dock moves to the floating platform construction site, from which the floating platform with the assembled wind turbine on it moves on the anchoring base in the dry-dock. There they are coupled and the dry-dock sinks, allowing them to free-float with sufficient waterplane area to provide needed stability during towing by tugs to an installation site. There, under control of three winches, each having a single wire rope that serves as a tether, the anchoring base is lowered to the sea bottom. After the anchoring base is installed, the winches on the floating platform pull it down below water to the project depth. This is done by combining winch pull with ballasting the inner space of the floating platform pontoon. This paper is a result of R&D investigation contracted by the National Renewable Energy Laboratories of the Department of Energy.

### SUMMARY OF THE PRESENT INVENTION

It is an objective of the present invention to provide means and methods for assembling wind turbines near shore in shallow waters, transporting them to their destination sites, and installing and anchoring them in deep waters in a manner of hours with a minimum of manpower and without the help of floating cranes, which leads to a significant reduction in installation and assembling time to thereby reduce the total cost of wind turbines installed in deep waters.

A deepwater windpower plant (“DWP”) according to the present invention uses a tension leg platform concept and comprises a typical offshore windmill assembled on a floating platform (tension leg platform) attached to a gravity anchoring base that rests on the ocean floor.

In accordance with a first aspect of the instant invention, a special onshore high-rise crane station with underwater supports is used for completely assembling the floating offshore windmill or generator. The crane installed at this station has a relatively short boom, which allows it to operate in relatively strong winds. Presently windmills are assembled with cranes having a very long boom (100+ meters), because of the need for placing the nacelle and the wind turbine on towers that are 80+ meters high. This restricts their operation to periods when winds are relatively weak. They are therefore not adapted for a year-round operation, especially in areas where strong rather than relatively weak winds are frequently encountered.

A second aspect of the instant invention employs a special catamaran-type vessel, also referred to herein as a “DWP installer”, with which floating wind turbines that were fully assembled close to shore are towed to destination sites while in their vertical positions. The DWP installer engagement and guiding arrangement allows the DWP free vertical movement due to wave action, but the degree of DWP inclination under wave and wind actions is limited by the stability of the catamaran-type vessel. In this manner the DWP can be delivered to a destination site even in moderately stormy seas.

A third aspect of the present innovation concerns the installation of the gravity anchoring base (GAB) and loading ballast in it.
In accordance with a first embodiment of the instant invention, the GAB is towed to the destination point as a pontoon in a form of an open box or container. The fully assembled tethers and power cable with buoys are loaded into the box, which is sunk to the ocean floor. After the GAB has been sunk to the ocean floor, dump barges unload suitable ballast, such as rock, for example, into the GAB. The use of this embodiment might not be practical in areas with strong currents and in deep waters, where unloaded ballast from dump barges might disperse over a large area and therefore not efficiently fill the GAB with ballast material.
In accordance with an alternative embodiment of the instant invention, the floating GAB is loaded with ballast near shore by cranes and assembled with the appropriate tethers and power cable. For the purpose of being floated and towed to a destination point, the GAB is provided with additional buoyancy formed by upward extensions of its side walls. It uses the same process of sinking to the ocean floor as was described in connection with the earlier described embodiment.

These embodiments of the innovation relating to the GAB include:
A special floating, stabilizing platform, for controlling the sinking of the GAB to the ocean floor, provides the condition that assures a flat landing of the GAB on the ocean floor. This simplifies its installation by eliminating the need for cranes that control the descent of the GAB to the ocean floor.
For future connection of the DWP to the GAB, tethers and the power cable are brought up to the ocean surface with buoys, which are attached to anchors on the GAB while the GAB is being lowered to the ocean floor. This creates the conditions needed for an automatic attachment of the DWP floating platform to the tethers.

A further embodiment of the invention uses an automated method of connecting the floating base of the wind generator to the tethers in a matter of minutes. In combination with pre-positioning the tethers near the surface, the need for multiple auxiliary vessels and cranes is eliminated, which are needed for conventionally connecting floating platforms to tethers attached to the anchoring base.

Another feature of the invention is the configuration of the tether, which utilizes multiple standard wire ropes or cables in the form of a loop instead of conventional steel tubular members used by the offshore industry for accommodating thousands of tons of force acting on tethers supporting tension leg platforms. The loop form of wire ropes simplifies the attachment and disconnection of wire ropes to and from the GAB. It also excludes the need for wire rope end connectors, which in the case of large diameter wire ropes are difficult to use and reduce the strength of wire rope connection.

The use of the DWP installer and the speedy method of disconnecting and reconnecting the DWP to the anchoring base provides conditions for replacing heavy parts of windmills or entire nacelles by floatingly moving the entire wind generator to a high-rise crane station, where required replacements can be done in a relatively short time and in a safe manner, and thereafter returning it to the offshore site for reinstallation.

### BRIEF DESCRIPTION OF THE DRAWINGS

FIG. 1 shows a deepwater windpower plant (DWP) during operation (elevational view);

FIG. 2 shows a deepwater windpower plant (DWP) during operation (side view);

FIG. 3 shows a floating base general arrangement (Section A-A from FIG. 5);

FIG. 4 shows a floating base general arrangement (side view);

FIG. 5 shows a floating base (plan view);

FIG. 6 is Detail I from FIG. 3;

FIG. 7 is Detail II from FIG. 5;

FIG. 8 is Detail III from FIG. 5;

FIG. 9 is a section taken along B-B of FIG. 8;

FIG. 10 shows Section C-C of FIG. 9;

FIG. 11 is View D from FIG. 9, without center cone 77;

FIG. 12 shows a tether in elevational view;

FIG. 13 shows a tether in side view;

FIG. 14 shows an empty gravity anchoring base (GAB) in plan view (Embodiment I);

FIG. 15 shows an empty GAB in section taken along E-E from FIG. 14;

FIG. 16 shows an empty GAB assembled with tethers in plan view;

FIG. 17 shows an empty GAB assembled with tethers along Section F-F of FIG. 16;

FIG. 18 shows a GAB installed on the ocean floor in plan view;

FIG. 19 shows a GAB installed on the ocean floor and is taken along Section G-G of FIG. 18;

FIG. 20 is Detail IV from FIG. 18;

FIG. 21 is a section view taken along H-H of FIG. 20;

FIG. 22 is a section view taken along K-K of FIG. 21;

FIG. 23 shows a stabilizing platform in plan view;

FIG. 24 shows a stabilizing platform in elevational view;

FIG. 25 illustrates the process of transporting and installing an empty GAB at Positions I and II;

FIG. 26 illustrates the process of transporting and installing an empty GAB at Positions III and IV;

FIG. 27 illustrates the process of transporting and installing an empty GAB at Positions V and VI;

FIG. 28 illustrates the process of transporting and installing an empty GAB at Positions VII and VIII;

FIG. 29 illustrates the process of unloading ballast from a dump barge into the GAB in an elevational view;

FIG. 30 illustrates the process of unloading ballast from a dump barge into the GAB in section;

FIG. 31 shows the DWP installer in elevational view;

FIG. 32 shows the DWP installer in side view;

FIG. 33 shows the DWP installer in plan view;

FIG. 34 shows the DWP installer, Detail IX from FIG. 32;

FIG. 35 shows the closed position of the DWP installer engaging guide;

FIG. 36 shows the open position of the DWP installer engaging guide;

FIG. 37 shows a floating platform delivered and installed on underwater supports near a high-rise crane station;

FIG. 38 illustrates the installation of the DWP tower;

FIG. 39 illustrates the installation of the DWP nacelle;

FIG. 40 illustrates the installation of the DWP wind turbine;

FIG. 41 shows the completed DWP and a DWP installer approaching it;

FIG. 42 shows the DWP installer engaging the DWP;

FIG. 43 is a plan section taken on H-H of FIG. 40;

FIG. 44 shows the DWP lifted from its underwater supports and connected to a tug;

FIG. 45 shows the DWP installer with the DWP being towed by tug to open sea in elevational view;

FIG. 46 shows the DWP installer with the DWP being towed by tug to open sea in side view;

FIG. 47 shows the DWP installer approaching mooring tethers;

FIG. 48 shows the DWP installer in elevation and the DWP engaged with mooring tethers;

FIG. 49 illustrates the process of engaging the floating base with the mooring tethers;

FIG. 50 shows in side view the DWP installer engaged with mooring tethers and tensioning them;

FIG. 51 is Detail X from FIG. 49;

FIG. 52 is Detail XI from FIG. 50;

FIG. 53 shows the DWP installer in the process of disconnecting the tether buoys 71;

FIG. 54 shows the DWP installer being towed away with attached tether buoys from the DWP;

FIG. 55 shows an empty gravity anchoring base (GAB) in plan view (Embodiment II);

FIG. 56 shows a floating empty GAB taken along Section L-L of FIG. 55;

FIG. 57 shows a ballast loaded GAB assembled with tethers in plan view;

FIG. 58 is a section of the GAB loaded with ballast and assembled with tethers taken along M-M of FIG. 57;

FIG. 59 shows a ballast loaded GAB installed on the ocean floor in plan view;

FIG. 60 shows a ballast loaded GAB installed on the ocean floor and is taken along N-N of FIG. 59;

FIG. 61 is Detail XII from FIG. 59;

FIG. 62 is Section O-O of FIG. 61;

FIG. 63 is Section P-P of FIG. 62;

FIG. 64 illustrates the process of transporting and installing an empty GAB at Positions I and II;

FIG. 65 illustrates the process of transporting and installing an empty GAB at Positions III and IV;

FIG. 66 illustrates the process of transporting and installing an empty GAB at Positions V and VI; and

FIG. 67 illustrates the process of transporting and installing an empty GAB at Positions VII and VIII.

### DESCRIPTION OF THE PREFERRED EMBODIMENTS

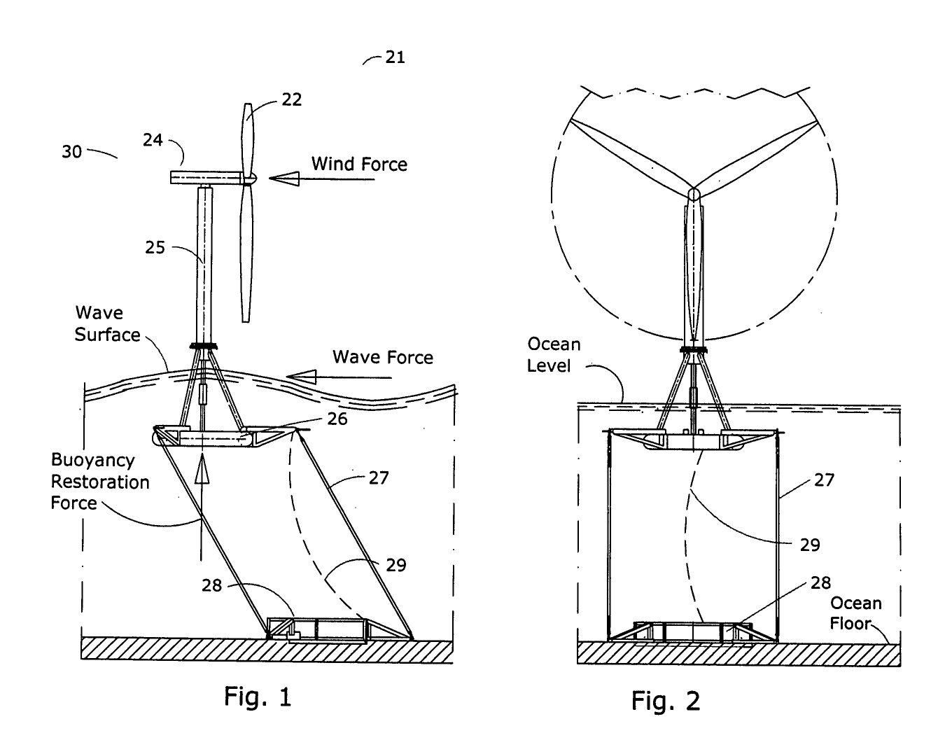

FIGS. 1 and 2 illustrate a deepwater windpower plant (DWP) 21 and its operation under wind and wave forces. It has a typical offshore wind turbine 22, with a nacelle 24, a floating platform 26, at least three tethers 27, the number of tethers preferably being an uneven number to prevent generating undesirable moments on a gravity anchoring base (GAB) 28, and a power output cable 29.

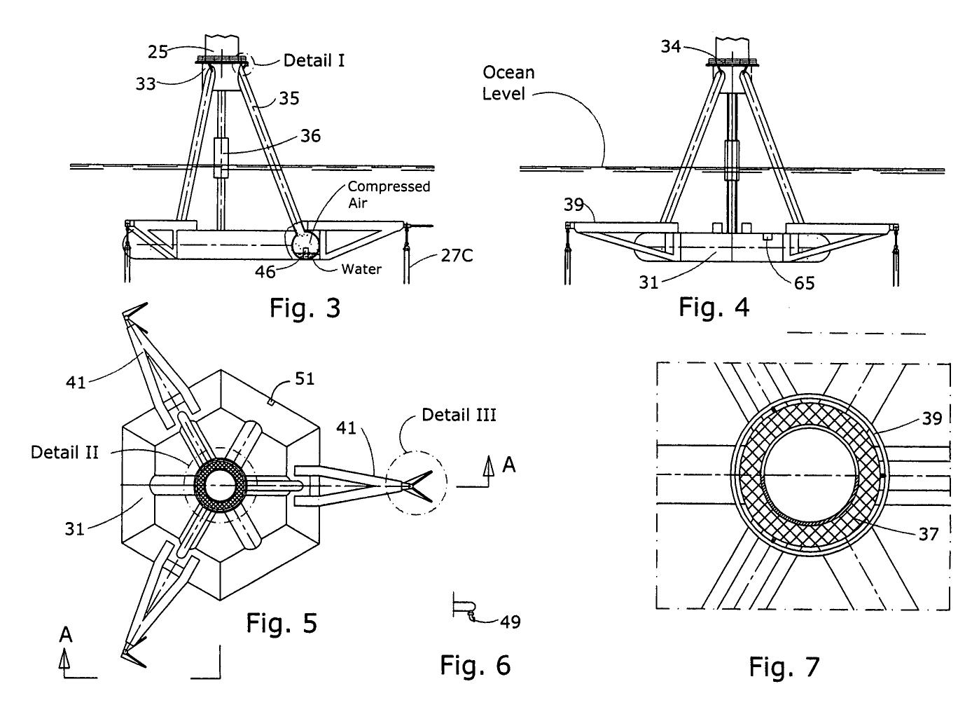

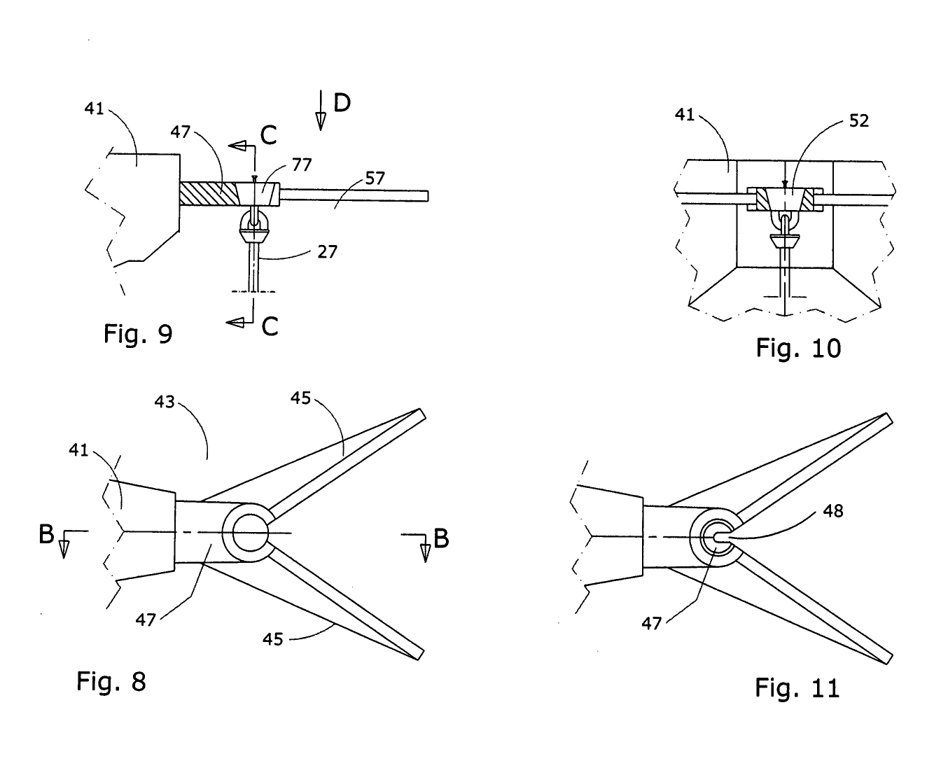

FIGS. 3 through 11 illustrate the design of floating platform 26. It has a doughnut-shaped pontoon 31, a boarding platform 33 having a flange 34 for the quick connection with a tower 25 of a typical offshore wind turbine, three legs 35 that connect pontoon 31 to boarding platform 33, and a central berthing post 36. Boarding platform 33 includes a deck 37 and a berthing ring 39, which also serves as a conduit for compressed air. The doughnut-shaped pontoon 31 is a vessel that can contain water and/or compressed air and it has on its bottom a remote controlled valve 46. Pontoon 31 has three equally spaced-apart outreach arms 41, each having on their outer end a tether catcher 43 defined by two bars 45 and a cone receptor 47. The cone receptor 47 (see FIG. 11) has an open slot 48 for tether 27 to enter it. Berthing ring 39 has a pipe outfit 49 for receiving compressed air. The inner space of berthing ring 39 is interconnected with the inner space of pontoon 31 through the inner spaces of legs 35 so that air can flow through the legs to the inside of pontoon 31. On the side of pontoon 31 is located box 51, to which the power cable 29 is connected.

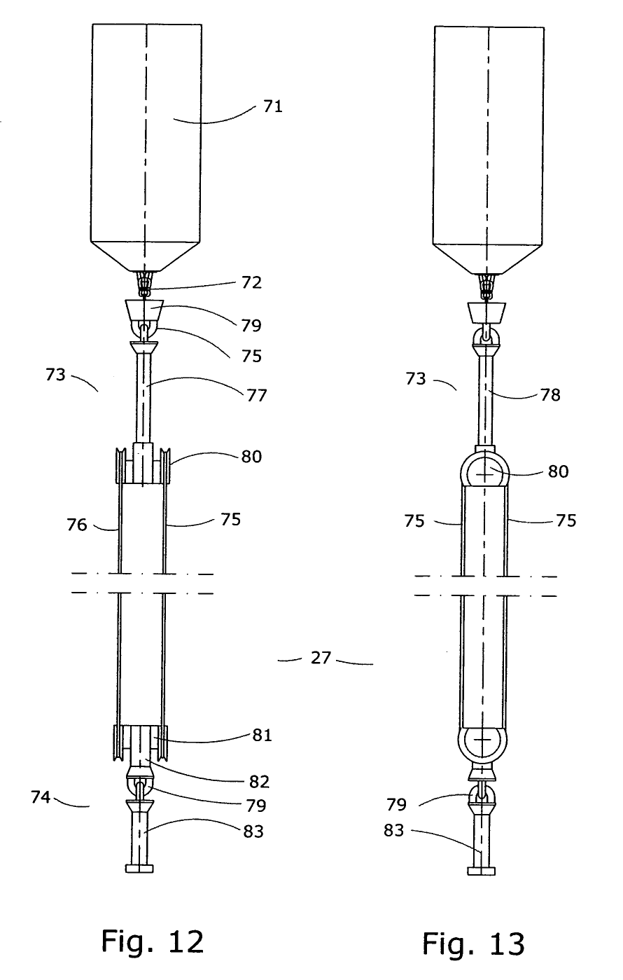

FIGS. 12 and 13 illustrate a tether 27 preassembled with a buoy 71 having a quick-disconnecting clutch or connector 72 for ease of releasing it from the tether. Tether 27 has an upper part 73 and a lower part 74, which are interconnected by a pair of wire ropes 75 and 76, each shaped as a loop. The upper part 73 includes a centering cone 77 connected to a rod 78 with a chain-type connector 79, which provides the capability of a universal joint, and to an upper wire rope receiver 80 in the form of half a circle. The lower part 74 includes a lower wire rope receiver 81, a rod 82 and an anchor 83, which is connected to a rod 82 through a chain-type connector 79.

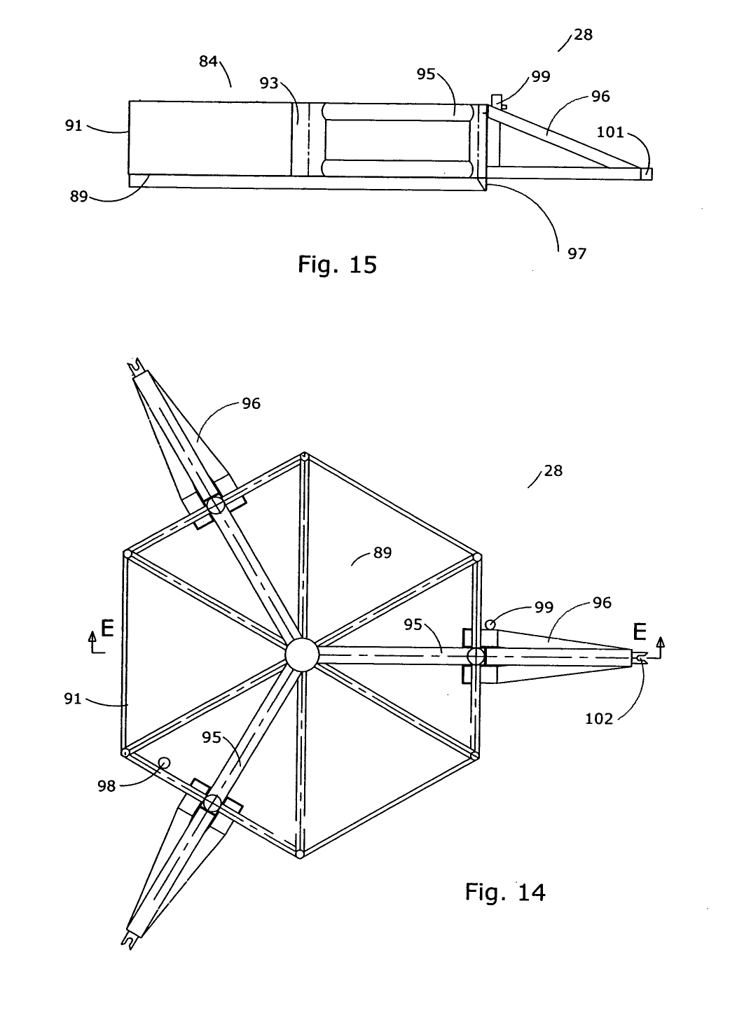

FIGS. 14 and 15 illustrate an empty GAB 28. The GAB is a box 84 to which are attached three equally spaced outreach levers 85. The box 84 has an open top and it includes a floor 89, walls 91, a central post 93, three girders 95, soil knives 97 located along the GAB perimeter, a valve 98, a power cable connector 99 and a tether connector 101 on each end of outreached levers 85. Each tether attachment 101 has a cut-out 102 for insertion of anchor 83 of tether 27. (See FIGS. 20-22)

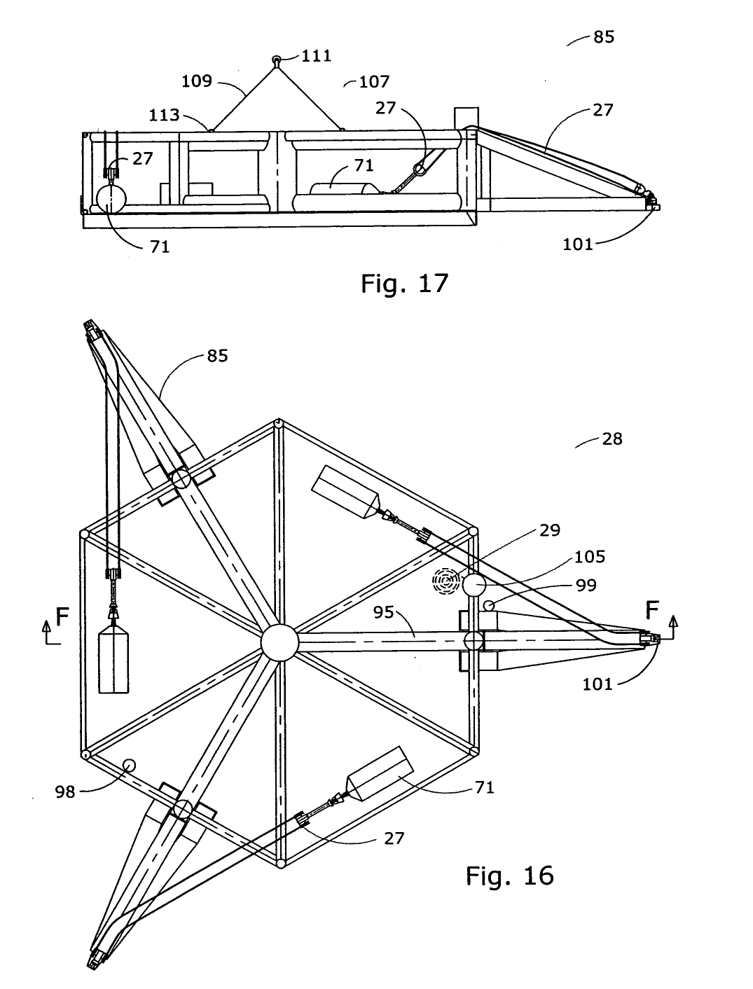

FIGS. 16 and 17 illustrate the empty gravity anchoring base assembled with tethers 27 having buoys 71 and a power cable 29 with a buoy 105 in accordance with one embodiment of the invention. FIG. 16 is a plan view and FIG. 17 is a sectional view. They also show a sling arrangement 107 having three ropes 109 assembled with one sheave 111 and attached to girders 95 through ears 113.

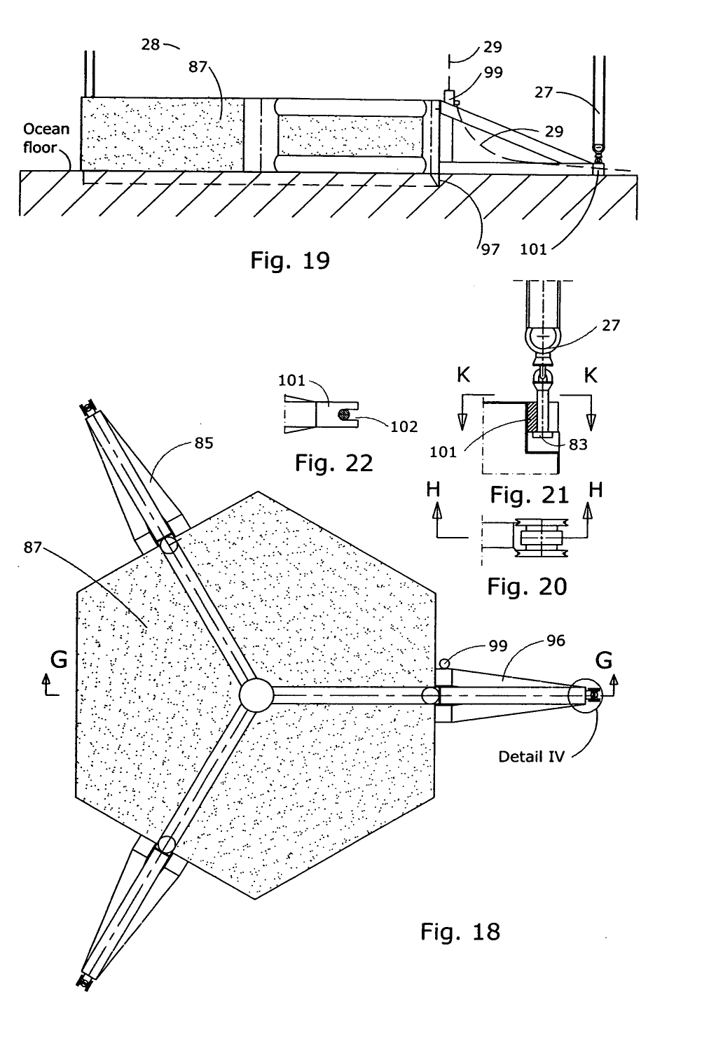

FIGS. 18 through 22 illustrate the installation of the gravity anchoring base, which is in a form of an open container filled with ballast 87 on the ocean floor. The drawings illustrate a GAB connected with tethers 27 through anchor 83 and a tether connector 101. The drawings also illustrate the extension of the power cable 29 from the GAB and the penetration of soil knives 97 into the ocean floor.

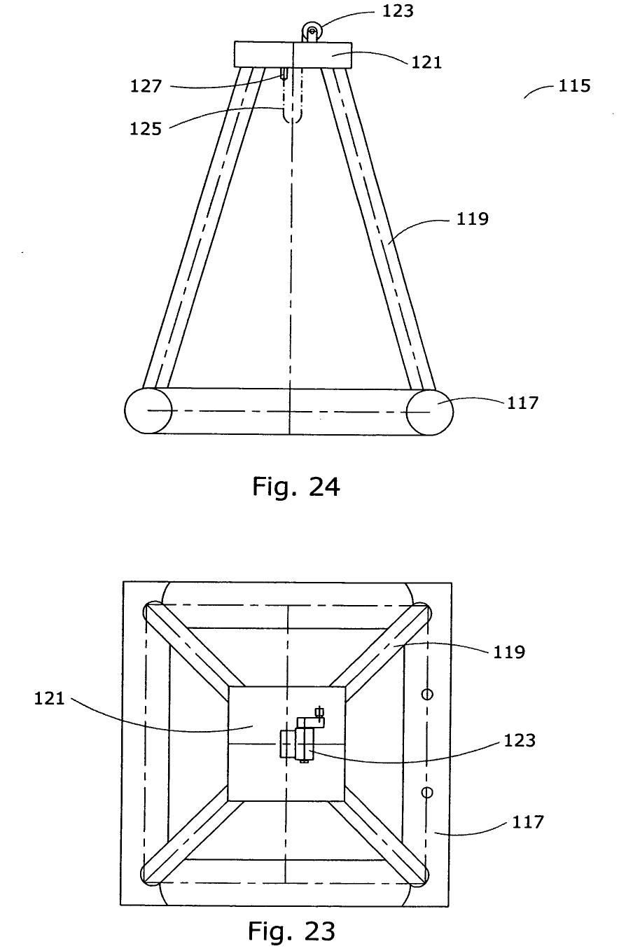

FIGS. 23 and 24 illustrate the configuration of a stabilizing platform 115, which provides the conditions so that at the end of it's sinking, the GAB lands flat on the ocean floor. It has a pontoon 117, four legs 119, a winch platform 121, a winch 123, a hoisting line 125 and a hoisting line quick release device 127.

### Transporting and Installing the GAB

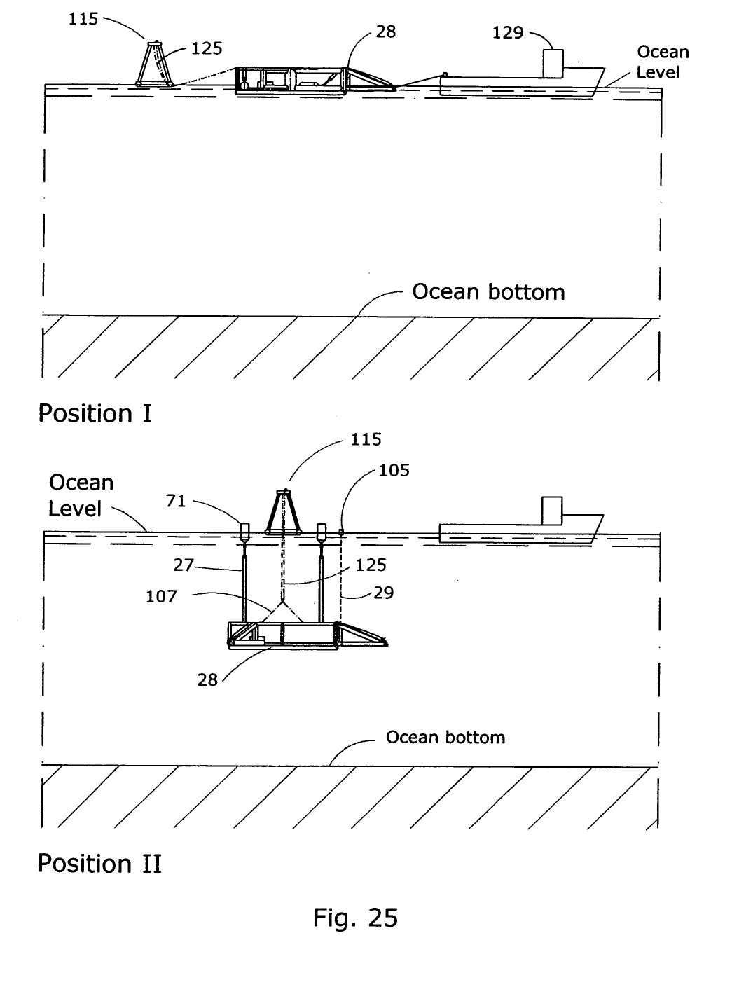

FIGS. 25 through 28 illustrate the sequence of positions during the process of transporting and installing an empty GAB in accordance with one embodiment of the invention.

Position I shows a tug 129 towing an empty GAB 28 that is followed by a stabilizing platform 115. The stabilizing platform 115 hoisting line 125 is engaged with a sheave 111 of the GAB sling arrangement 107 (shown in FIG. 17).

Position II (FIG. 25) shows an intermediate position of a free-sinking GAB 28. At this position the tether buoys 71 have reached the ocean surface and partially pull tethers 27 and wire ropes 75 and 76 out of the GAB, while a buoy 105 pulls power cable 29 partially out of the GAB. The initial limited force acting in the hoisting line 125 causes movement of the stabilizing platform 115 toward the GAB center.

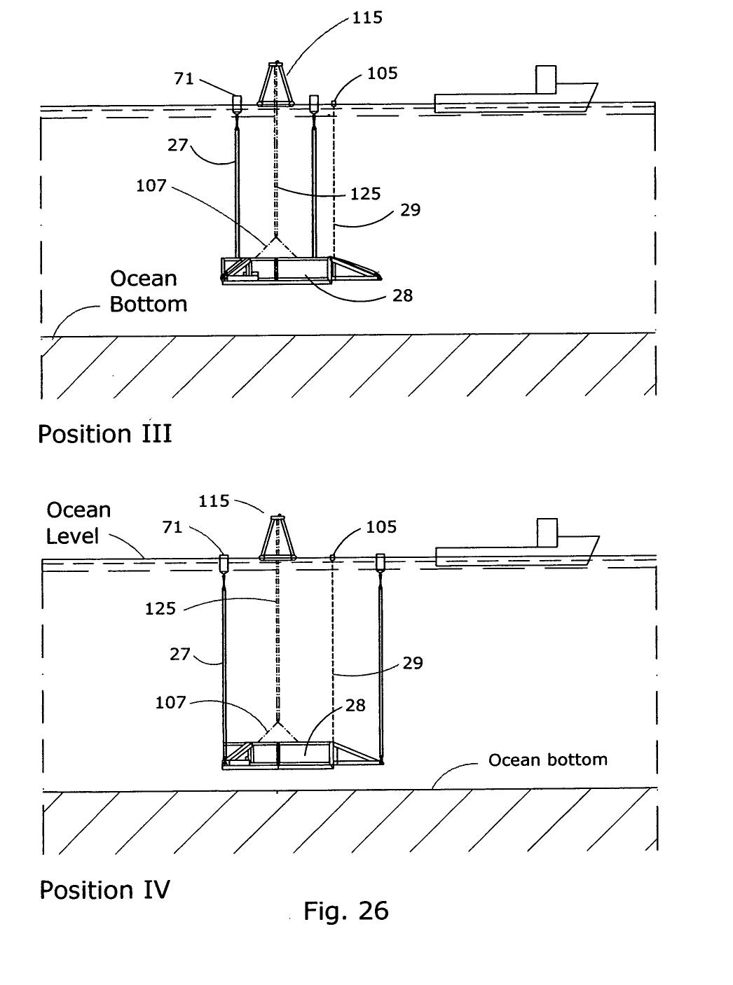

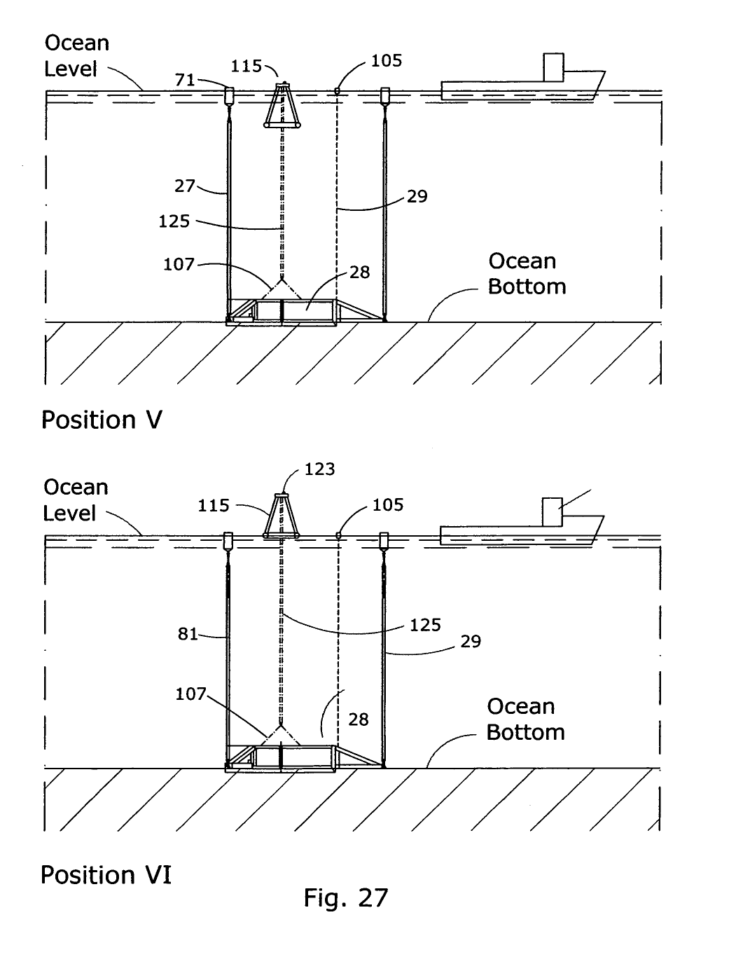

Position III (FIG. 26) shows further sinking of the GAB under the limited force, which causes winch 123 to pay out hoisting line 125 as the GAB descends.

Position IV (FIG. 26) shows the moment when the GAB has descended to about 10 meters above the ocean floor and winch 123 stopped paying out hoisting line 125. The gravity force exerted by the GAB then starts to sink the stabilizing platform. Under this force the slings 109 and sheave 111 (see FIG. 17) are located above the GAB's center of gravity. This causes the GAB to become horizontally (generally parallel to the ocean floor) oriented even if it was partially inclined during its free-sinking downward movement.

Position V (FIG. 27) shows that the GAB has reached the ocean floor and the stabilizing platform is almost fully submerged, leaving only winch platform 121 above the ocean surface.

Position VI (FIG. 27) shows stabilizing platform 115 resubmerged to the ocean surface. This is achieved by gradually releasing hoisting line 125 from winch 123.

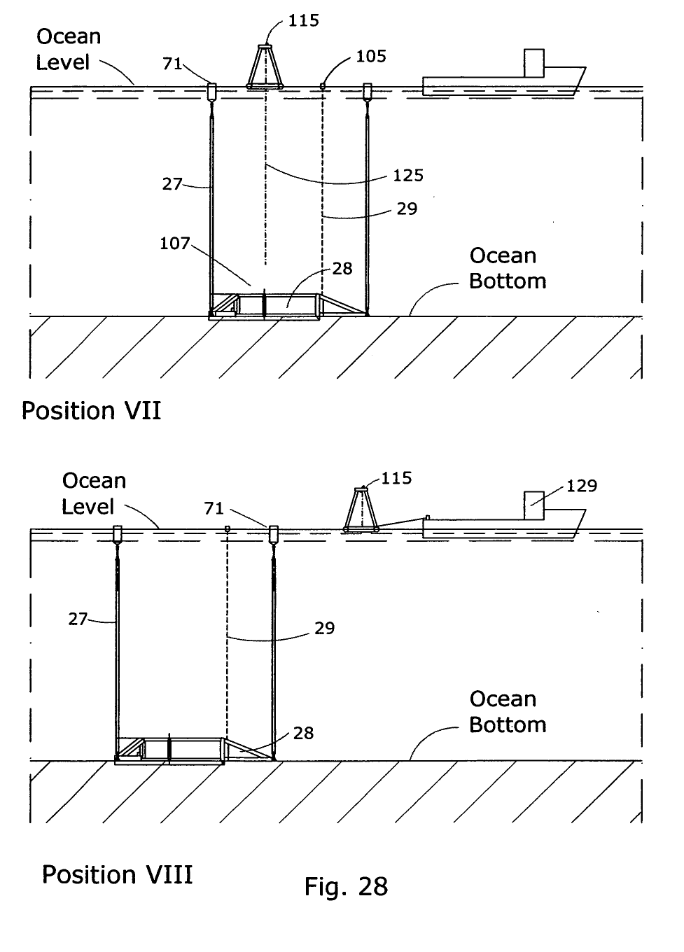

Position VII (FIG. 28) shows one end of hoisting line 125 detached from quick release device 127 while the remaining hoisting line 125 is wound up by winch 123.

Position VIII (FIG. 28) shows the installed GAB with buoys 71 and 105 floating on the ocean surface, tensioned tethers 27 and power cable 29, and stabilizing platform 115 being towed away by tug 129.

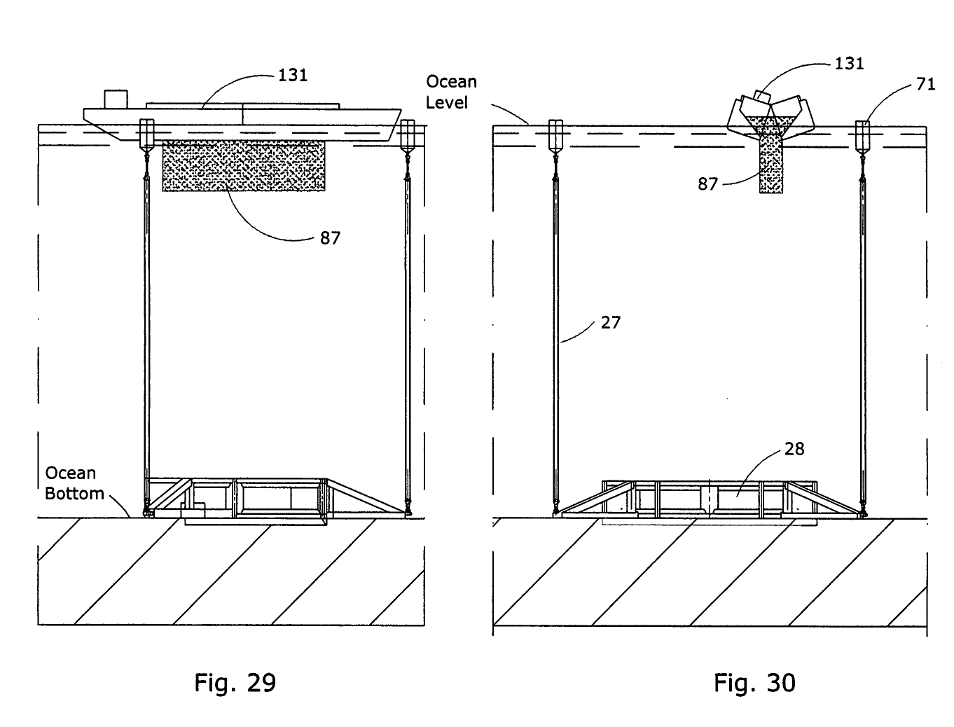

FIGS. 29 and 30 illustrate the unloading of ballast material 87 into a GAB 28 installed and resting on the ocean floor. FIG. 29 is an elevation of a dump barge 131 positioned vertically above GAB 28. FIG. 30 is a section taken through the middle of dump barge 131.

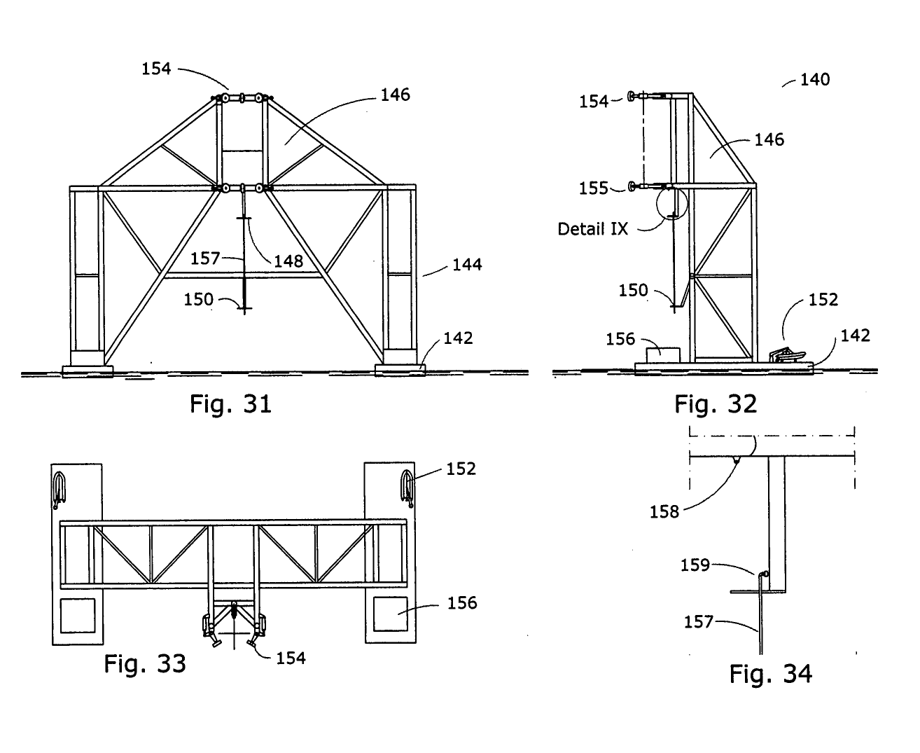

FIGS. 31 through 36 illustrate a DWP installer 140 used for transporting the assembled DWP from its assembly site close to shore to a position vertically above the GAB on the ocean floor. The DWP installer has two barges 142, a cross-connecting structure 144, which includes a support tower 146, an upper service platform 148, a lower service platform 150 and two upper and lower engaging clamps 154 and 155 which secure the DWP to the DWP installer 140. On the barge's decks there are two workboat stations 152, two machinery rooms 156 containing, for example, a diesel generator, an air compressor and a hydraulic power pack, which are not shown. The cross-connecting structure 144 includes a pneumatic hose 157, a winch 158 for handling it and an output valve 159, to which compressed air is delivered from the compressor in machinery room 156 through the inner space or spaces of the tubular elements of barge connecting structure 144.

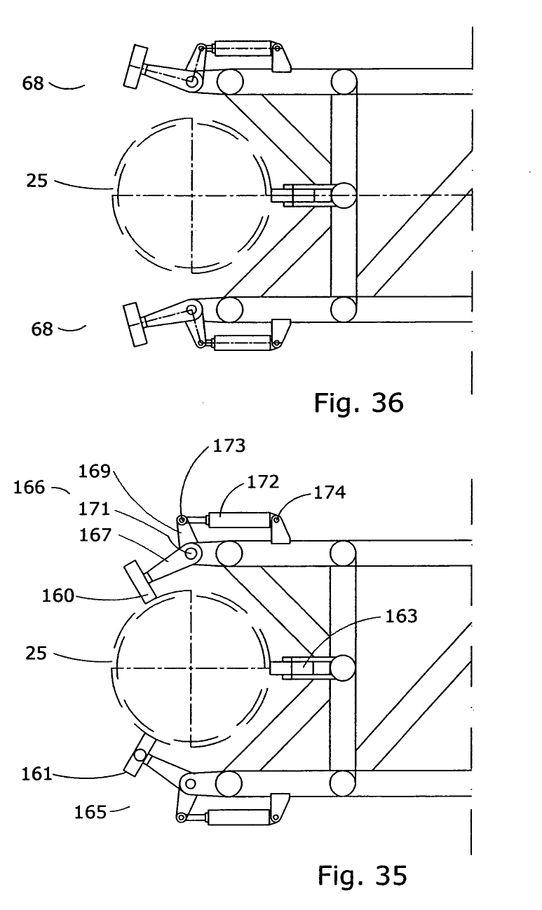

FIGS. 35 and 36 illustrate engaging clamps 154 and 155 in their open and closed positions. Each of them has three rollers 160, 161 and 163, which in their closed positions engage tower 25. Rollers 160 and 161 are attached to the arms of two pivoting levers 165 and 166. Roller 163 is fixed to support tower 146. Two arm pivoting levers 165 and 166 each have two bars 167 and 169. Both have a common pivot axis 171. Bars 167 have on their ends roller 160 or 161. Bars 167 and 169 are connected by pins 173 to actuators such as a pneumatic or hydraulic cylinder 172. Cylinder 172 is connected to support tower 146 with a pin 174.

### Delivery and Installation of Gravity Anchoring Base at the Destination Point

The delivery process of gravity anchoring base 28, which is assembled with tethers 27 and power cable 26, to the destination point and lowering it to the ocean floor is illustrated by FIGS. 25 through 28 and is done in the following order:
Position I (FIG. 25). The gravity anchoring base (GAB) 28 and stabilizing platform 115 attached to it are towed as a pontoon to the designated site by tug 129.
Position II (FIG. 25). Lowering GAB 28 begins by opening valve 99 (FIG. 14), which allows water to flow into GAB 28, thereby causing it to sink. As soon as the GAB 28 is fully submerged, it causes a slight tensioning of hoisting line 125 with sling 107 and in this manner pulls the stabilizing platform towards the center of the sinking GAB. The sinking GAB continues to pull hoisting line 125 from winch 123 under limited tension. The sinking of the GAB prompts buoys 71 and 105 to rise upwardly in the water, which pulls tethers 27, wire ropes 75 and 76 and power cable 29 out of the GAB and upwardly towards the ocean surface.
Position III (FIG. 26). The free-hanging length of hoisting line 125 is chosen to allow GAB 28 to descend downwardly until the stabilizing platform is positioned above the center of gravity of the GAB. At this point the winch 123 starts to pay out hoisting line 125 while maintaining a certain tension force in the line to thereby horizontally level the descending GAB 28.
Position IV (FIG. 26). The length of the wire ropes 75 and 76 and the height of the buoy 71 are chosen so that tethers 27 are fully pulled out from the GAB when the GAB is positioned about 10 meters above the ocean floor. At this point, winch 123 is stopped and as a result the stabilizing platform 115 begins to sink with the sinking GAB. The created buoyancy force is applied to the GAB through sling 107 and prompts the GAB center of gravity to be located under the hoisting line 125 while the GAB is in a horizontal position even if was initially in an inclined orientation.
Position V (FIG. 27). The GAB has landed flat on the ocean floor and stabilizing platform 115 has been submerged so that only winch platform 121 is located slightly above the ocean surface.
Position VI (FIG. 27). Winch 123 starts to slowly pay out hoisting line 125, which permits the stabilizing platform to rise from the submerged position until it starts to becomes free-floating again.
Position VII (FIG. 28). The quick-disconnect device 127 (FIG. 24) releases one end of hoisting line 125 so that winch 123 can wind up the entire hoisting line 125. Position VIII (FIG. 28). Hoisting line 125 has been fully wound up on the hoisting winch 123, and tug 129 pulls stabilizing platform 115 away from the installed GAB.

The process of loading ballast 87 into the GAB is illustrated by FIGS. 29 and 30. The dump barge is located between buoys 71 and opens its bottom, from where ballast gravitationally slides downward toward and into the GAB. To fill up the GAB with sufficient ballast might require unloading several dump barges, in part also because some ballast might spill over onto the sea bottom outside the GAB.

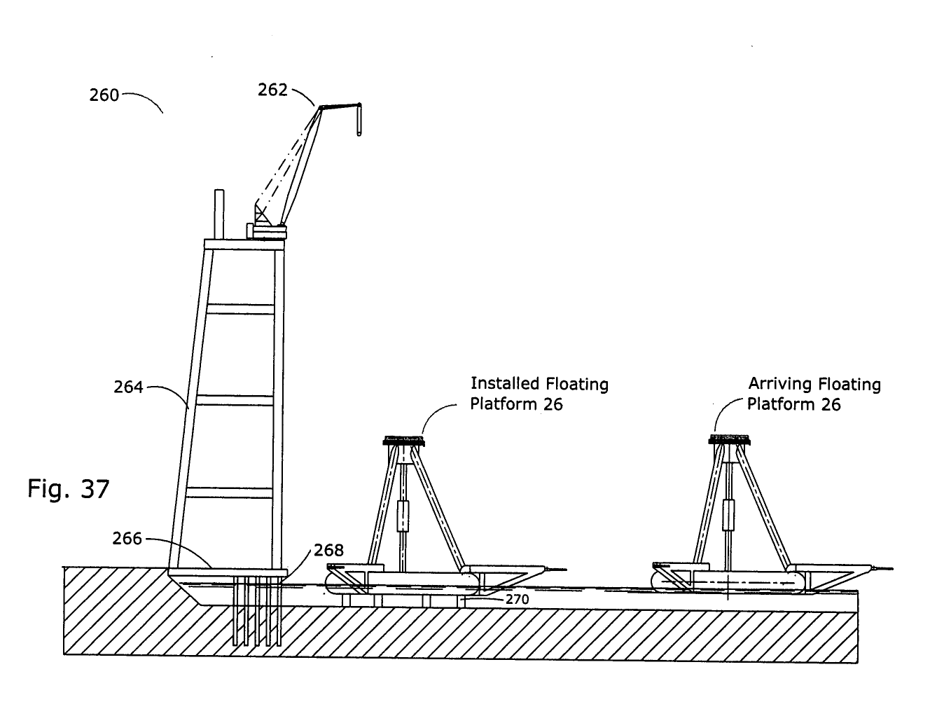

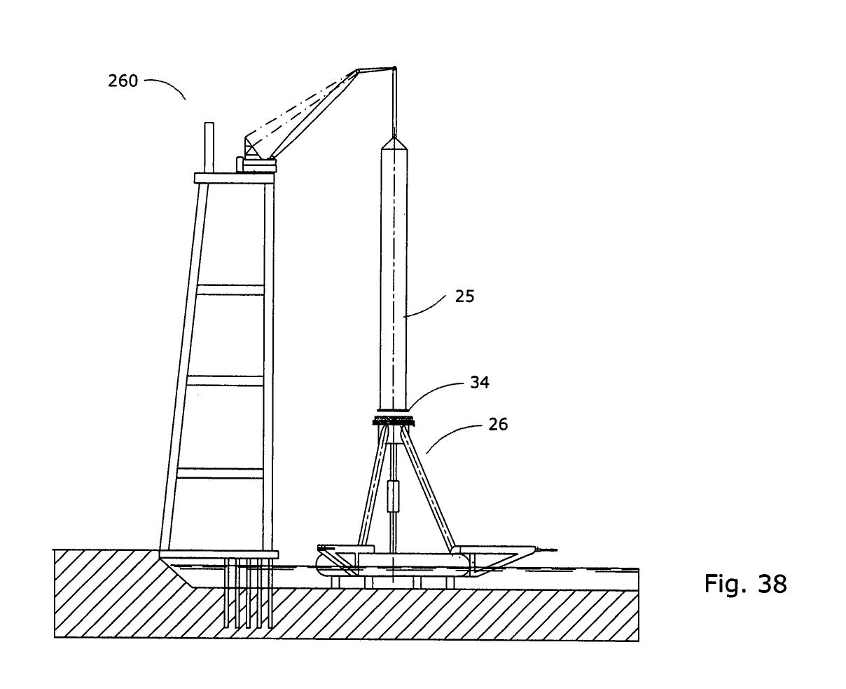

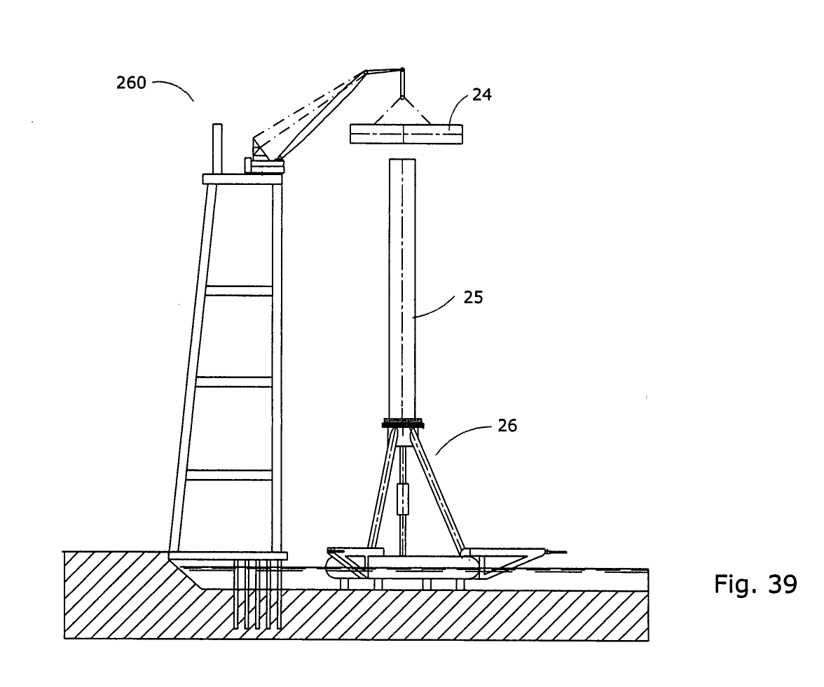

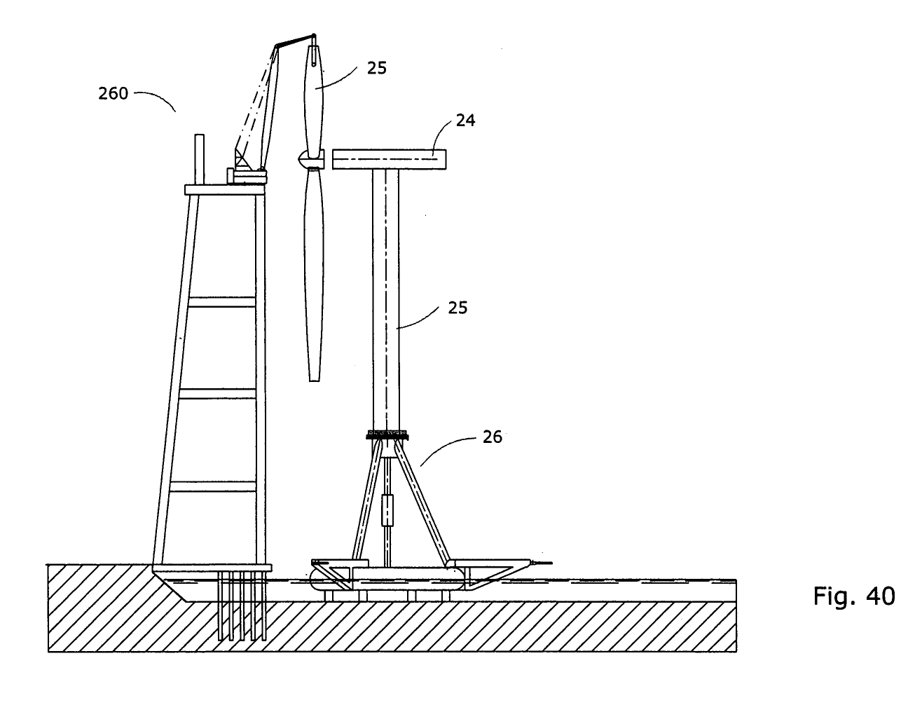

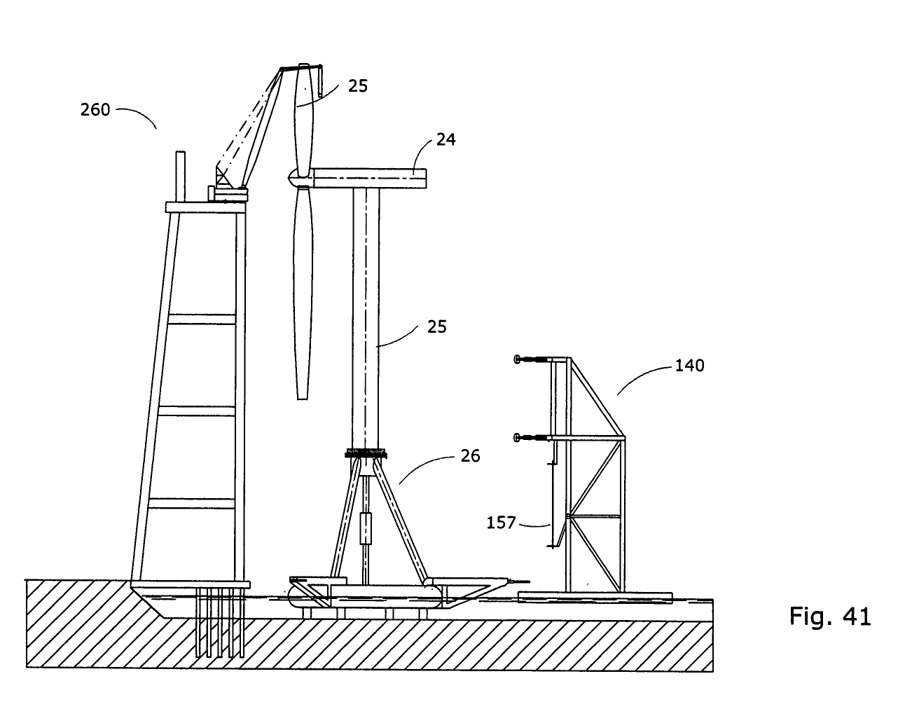

The process of assembling of the DWP at high-rise crane station 260 is illustrated by FIGS. 37 through 41 and is performed as follows:
The floating platform 26 is towed to high-rise crane station 260 close to shore, which has a crane 262, a pedestal 264 and a pier 266 on a piled foundation 268. At the moment when floating platform 26 is positioned above underwater supports 270, the valve 46 (see FIG. 3) opens and entering water will sink floating platform 26 onto underwater supports 270. When platform 26 reaches the ocean floor, valve 46 is closed.
The tower 25 is installed by crane 262 and is connected to the floating base 26 with flange 34.
The wind turbine nacelle 24 is installed by crane 262 at the top of tower 25.
The wind turbine 22 is then attached to the nacelle by crane 262.

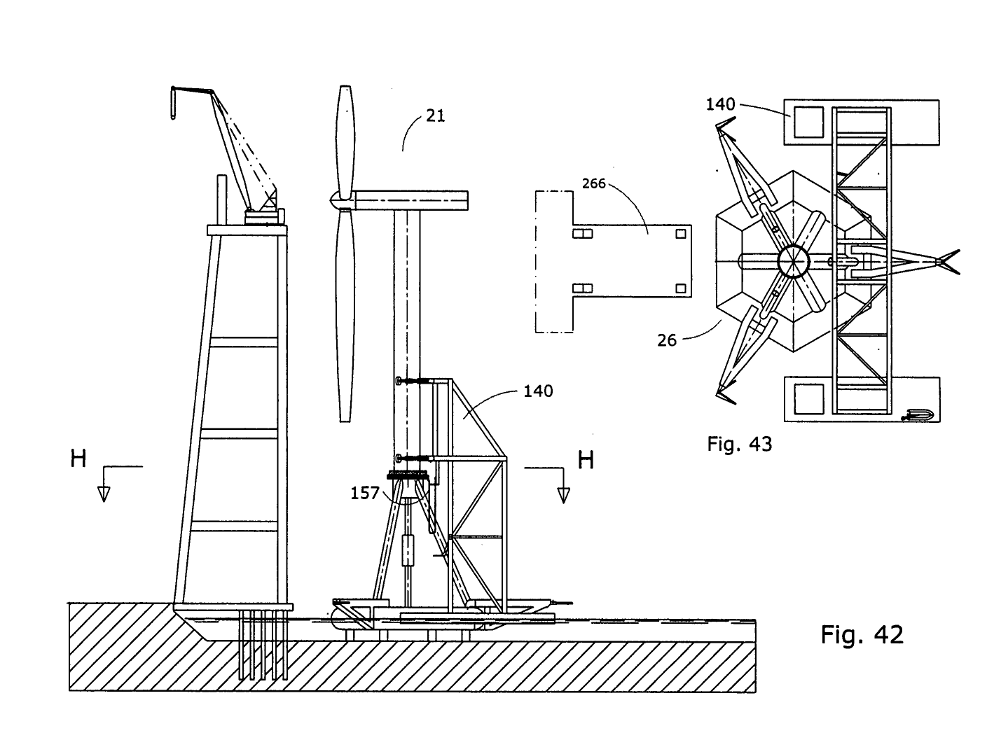

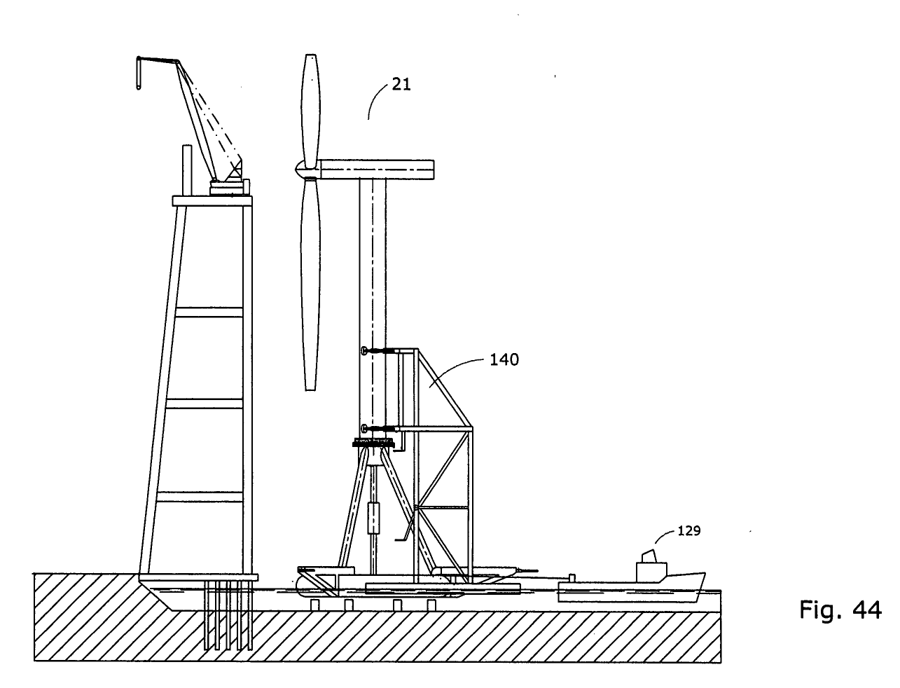

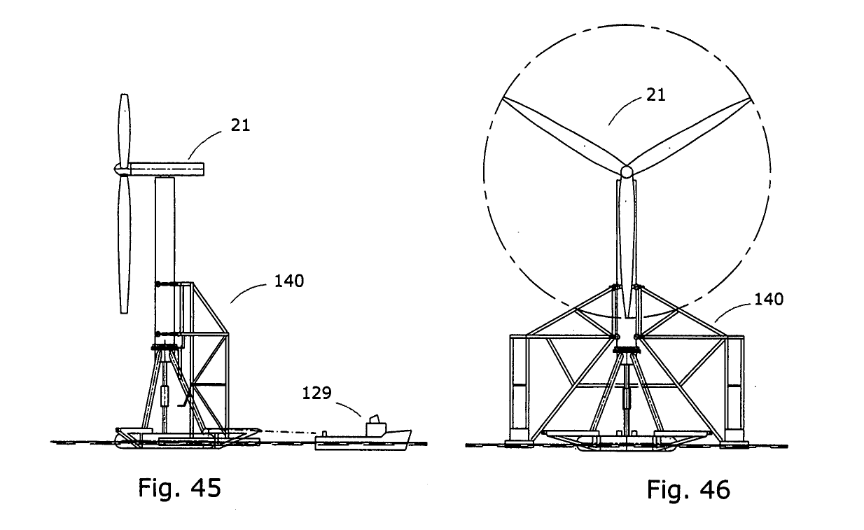

The process of engaging the assembled DWP with DWP installer 140, lifting it from underwater supports 270, and floating them together is illustrated by FIGS. 42 through 46 and is performed as follows:
The DWP installer 140 moves to the DWP installed at high-rise crane station 260 with its engaging clamps 154 in the open position (see FIG. 33). When guiding roller 163 comes in contact with tower 25, the two lever arms 165 and 166 are activated and their rollers 160 and 161 come in contact with and engage tower 25 (see FIG. 34).
Pneumatic hose 157 is lifted with winch 158 and connected to floating platform 26 pipe outfit 34 (see FIGS. 6, 34 and 41). Through hose 157 and the hollow internal space of floating platform 26 leg 35, the compressed air is pumped inside floating platform 26, thereby pushing water out through open valve 46. This prompts the entire DWP to float upwardly from underwater supports 270 to the surface. In this position, valve 46 is closed. The DWP is submerged sufficiently to only keep it afloat, thus minimizing its towing resistance.
The DWP and DWP installer are coupled together and towed by the tug to the destination site.

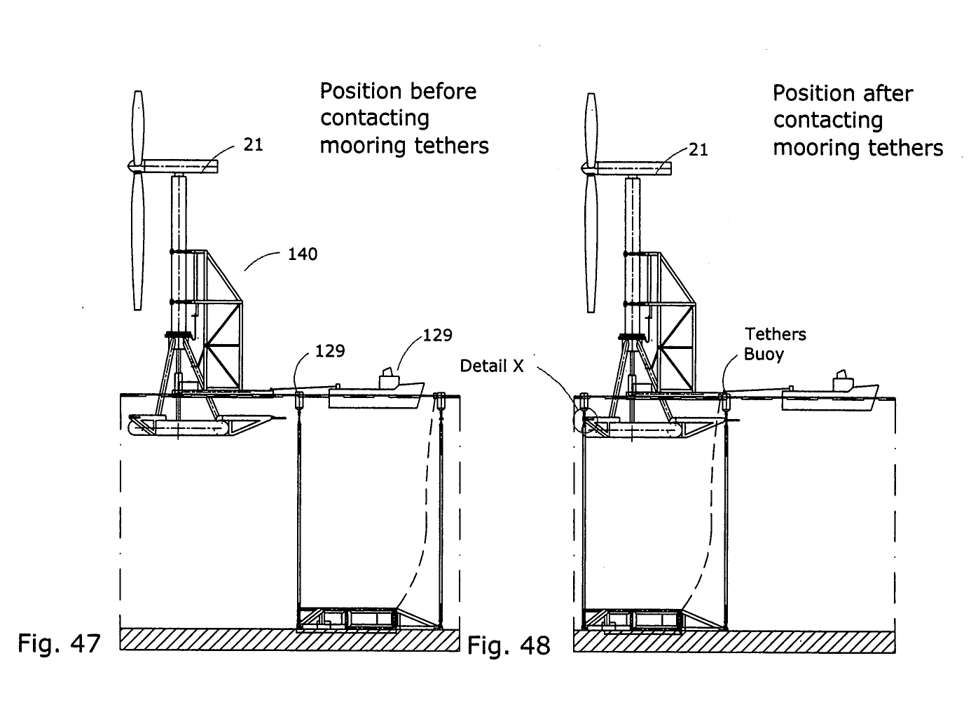

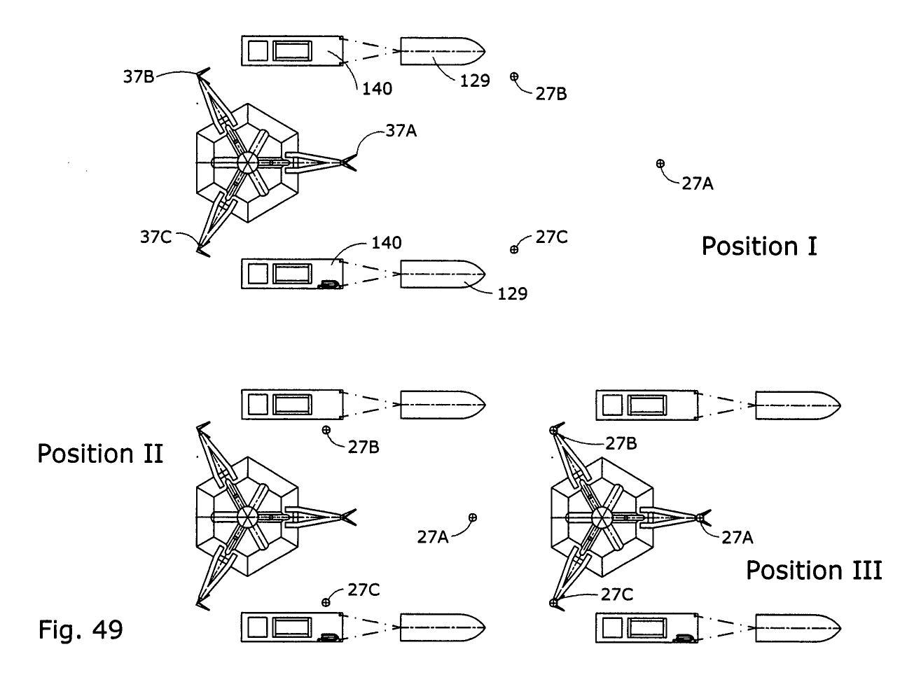

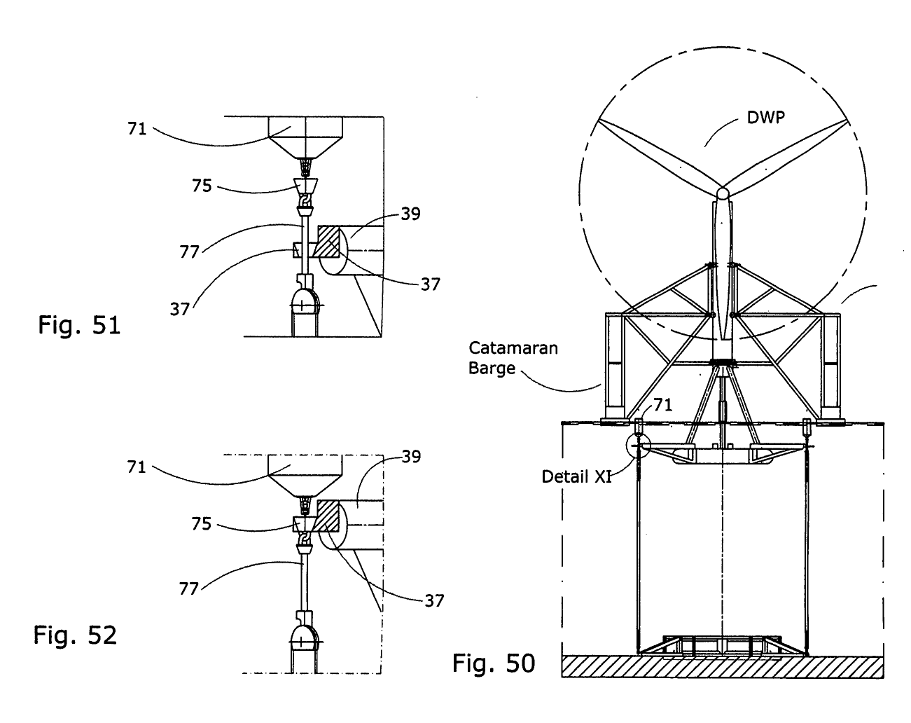

The process of anchoring the DWP at the designated site is illustrated by FIGS. 47 through 53 and is performed as follows:
The DWP installer 140 stops near the designated site (see FIG. 47), where three buoys 71 and their supporting tethers 27 already float on the ocean surface.
Before engaging tethers 27, valve 46 is opened so that water can flow inside floating platform 26. The floating platform 26 will then sink to a position where the level of tether catchers 37 meets the middle level of the rods 77 of tethers 27 (see FIG. 51) and valve 46 is closed to stop further sinking of floating platform 26.
After reaching the desired depth of submergence, the DWP is towed by tug 129 toward the vertically oriented, tensioned tethers 27. Engaging the DWP with tethers 27 in place is illustrated by FIG. 49.
After all tethers 27 are trapped into their respective tether catchers 37, the pumping of compressed air into floating platform 26 resumes and water from it flows out through open valve 46.
When almost all water has been pumped out of floating platform 26, tethers 27 are pretensioned to the degree that provides sufficient restoration forces for DWP to withstand hurricane winds and resulting wave actions. At this position, valve 46 is closed.
The power cable is detached from buoy 105 and attached to connector 51 on the floating platform 26.

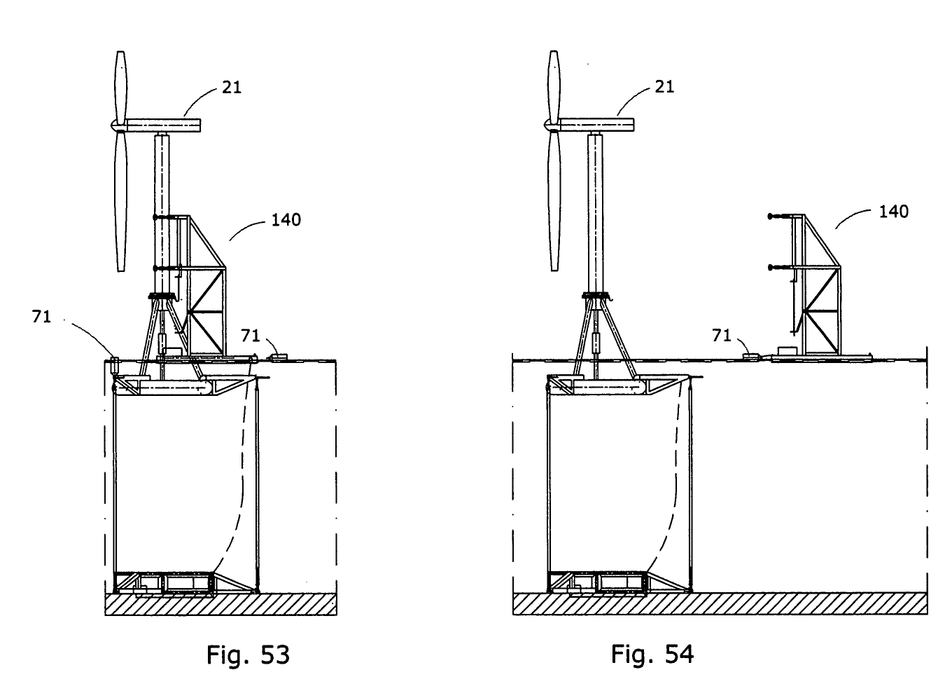

The final installation of the DWP at the designated site is illustrated by FIG. 53 and FIG. 54 and is performed as follows:
Buoys 71 are released from tethers 27 by activating disconnecting clutch 73.
Hose 157 is disconnected from floating platform 26.
Buoys 71 are attached to DWP installer 140.
The engaging clamps 154 are moved into their open positions.
The DWP installer is then towed back to port, towing buoys 71 behind it.
The DWP is ready to start generating electricity.

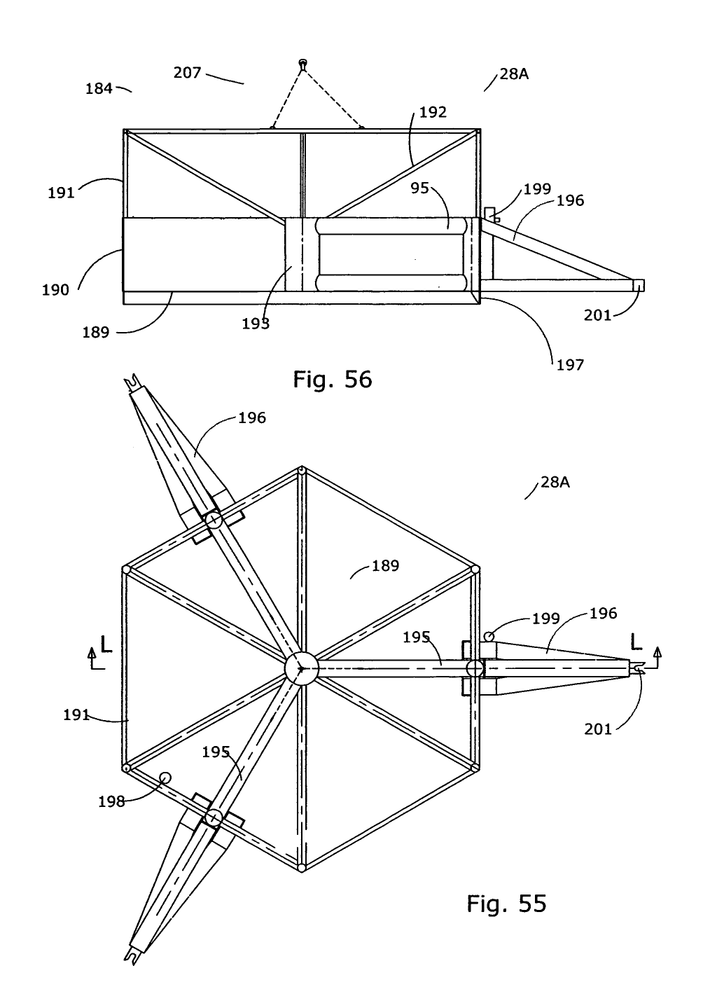

One embodiment of the gravity anchoring base (GAB) 28A is illustrated by FIGS. 55 and 56. FIG. 55 shows GAB 28A in plan view. FIG. 56 shows a section view through an empty GAB 28A floating on the ocean surface. GAB 28A is a box 184 to which are attached three equally spaced outreach levers 185. The box 184 has an open top and a floor 189, upwardly extending base walls 190, further upwardly protruding extended walls 191 above walls 190 with reinforcement brackets 192, a central post 193, three girders 195, soil knives 197 located along the GAB perimeter, a valve 198, a power cable connector 199 and a tether connector 201 on the end of each outreach lever 185. Each tether attachment 201 has a cut-out 202 (FIG. 63) for inserting anchor 183 of tether 27.

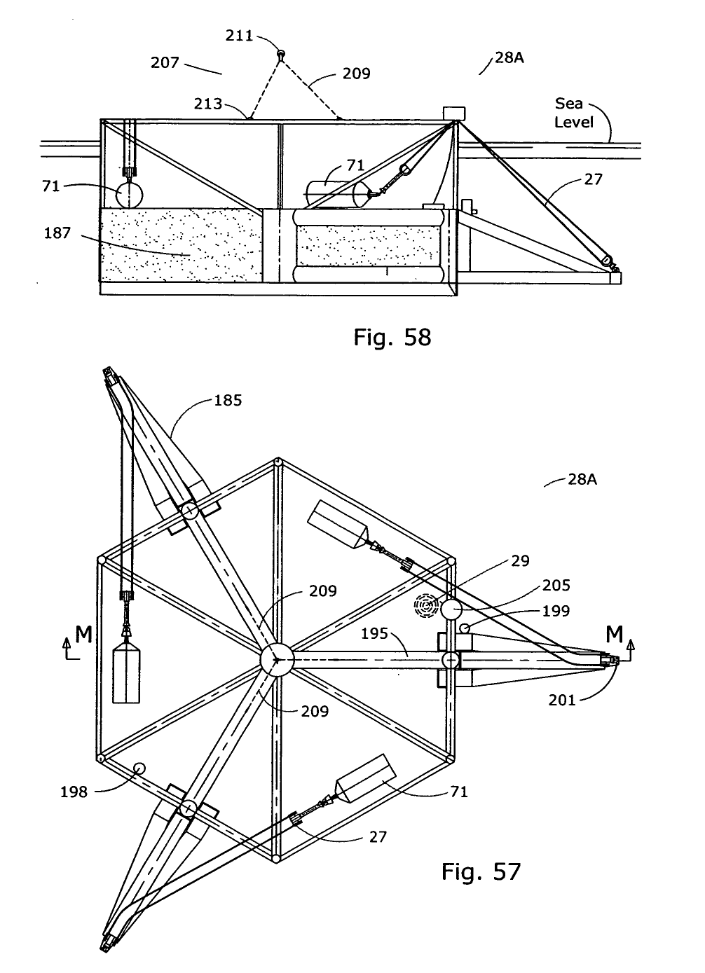

FIGS. 57 and 58 illustrate GAB 28A loaded with ballast and assembled with tethers 27 having buoys 71 and a power cable 29 attached to another buoy 105. FIG. 57 is a plan view, and FIG. 58 is a section view of GAB 28A floating on the ocean surface. The drawings also show a sling arrangement 207 having three ropes 209 assembled with one sheave 211 and attached to girders 195 through ears 213.

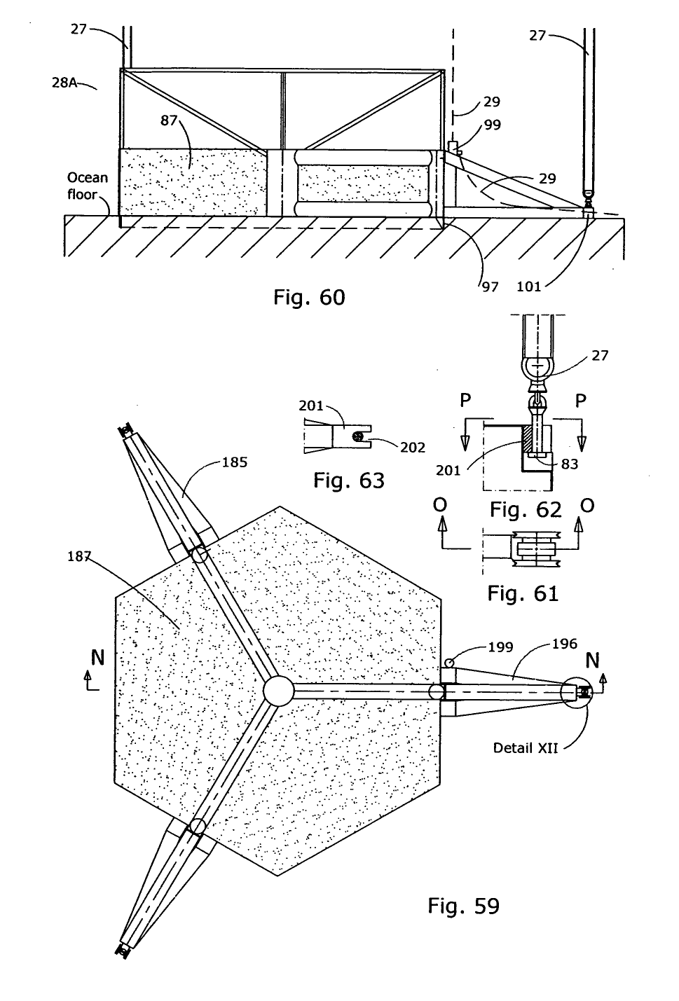

FIGS. 59 through 63 illustrate the installation of gravity anchoring base 28A filled with ballast 187 on the ocean floor. GAB 28A is in engagement with tethers 27 and its anchor 83 through connector 201. Also shown are an extension of the power cable from the GAB and the penetration of soil knives 97 into the ocean floor.

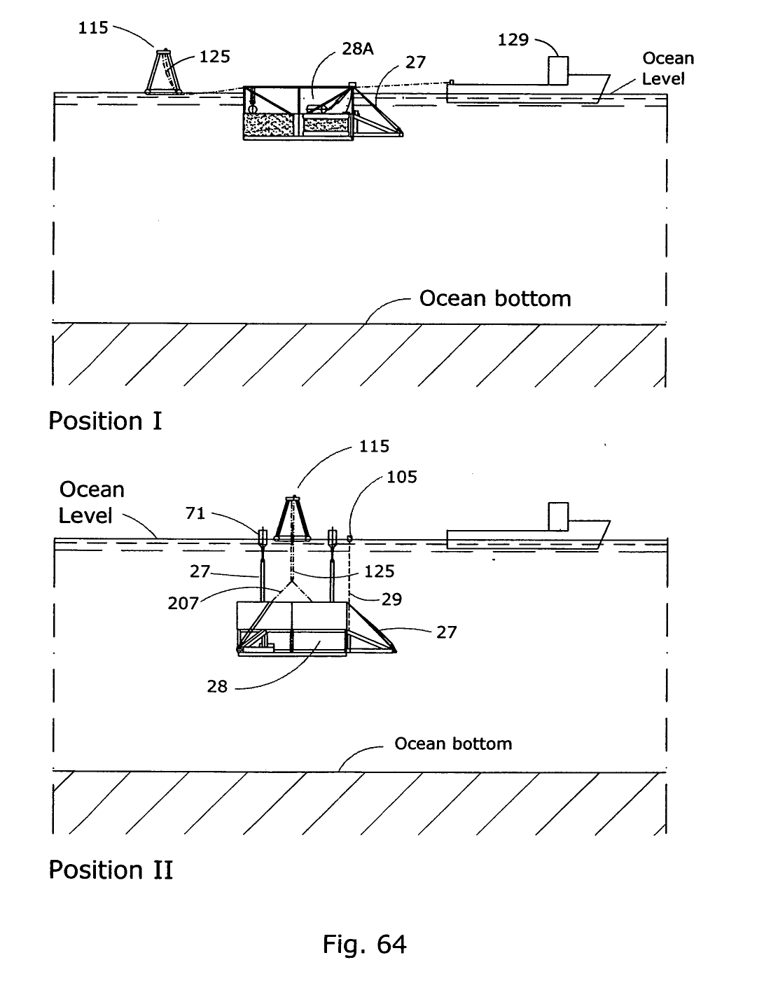

FIGS. 64 through 67 illustrate the sequence of positions during the process of transporting and installing the GAB according to another embodiment of the invention.

Position I (FIG. 64) shows tug 129 towing GAB 28A that is fully loaded with ballast and assembled with tethers 27 and power cable 29 with the associated stabilizing platform 115 being towed behind. The stabilizing platform 115 hoisting line 125 is engaged with sheave 211 of the GAB 28A sling arrangement 207.

Position II (FIG. 64) shows an intermediate position of the free-sinking GAB 28A. At this position the tether buoys 71 have reached the ocean surface and partially pull wires ropes 75 and 76, while buoy 105 pulls power cable 29 partially out of GAB 28A. The initial limited tension force in the hoisting line 125 moves stabilizing platform 115 toward the GAB 28A center.

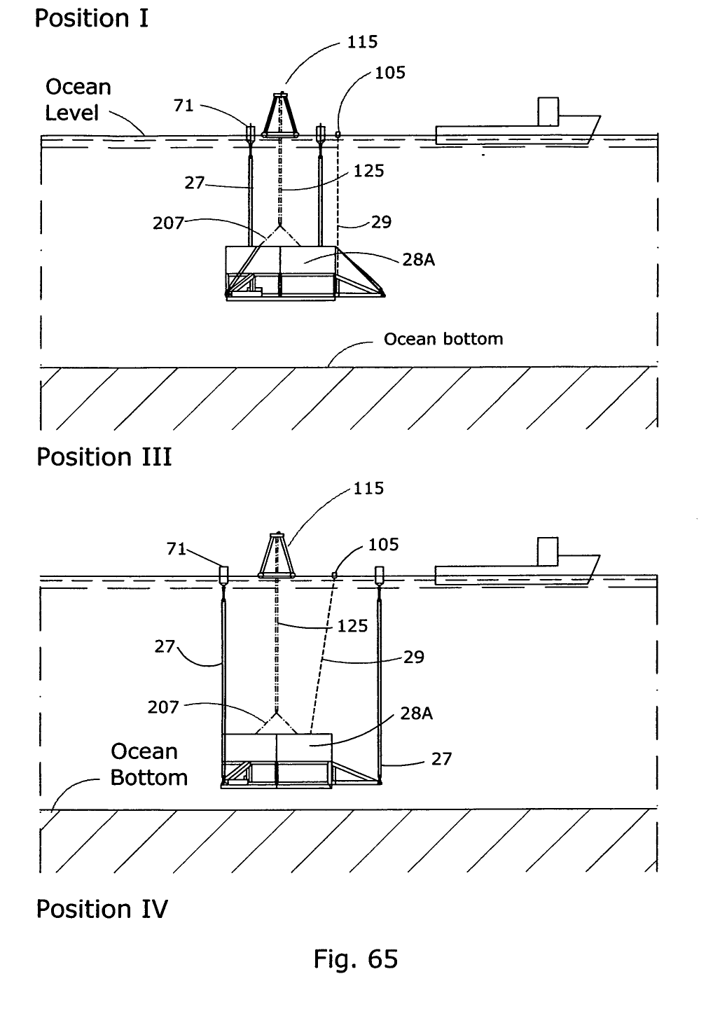

Position III (FIG. 65) shows a further sinking of GAB 28A under the limited tension force in the hoisting line applied by winch 123, which pays out hoisting line 125 as GAB 28A descends.

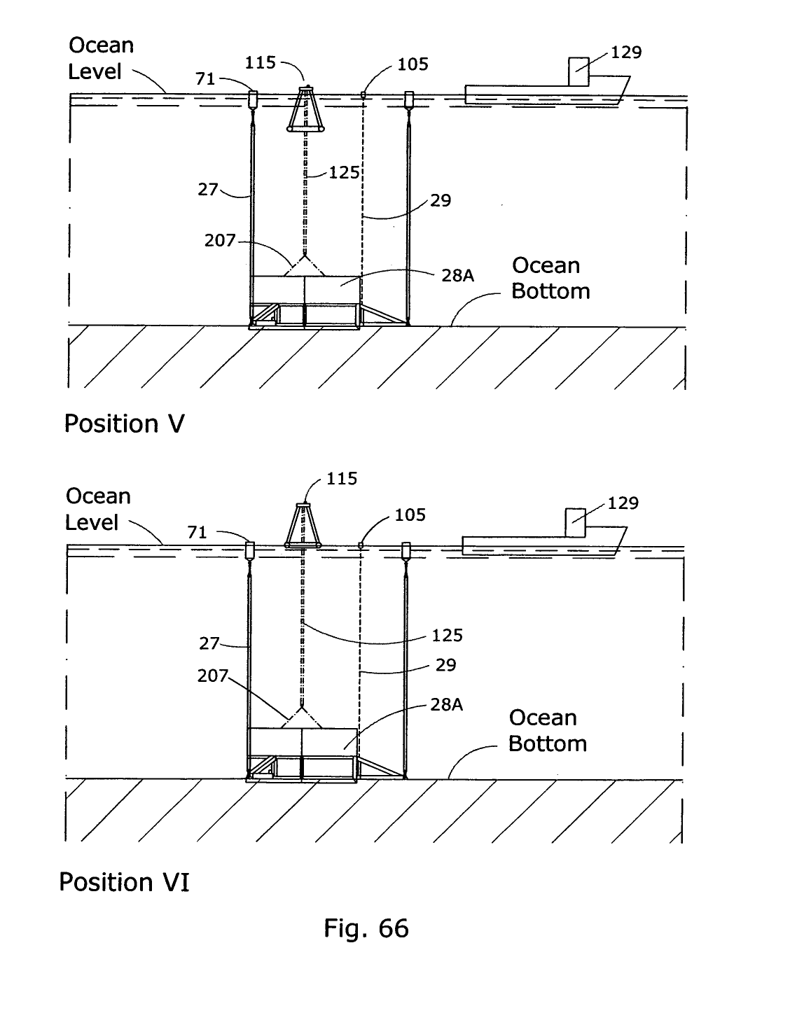

Position IV (FIG. 65) shows that GAB 28A has descended to about 10 meters above the ocean floor, at which point winch 123 stops paying out hoisting line 125. The force of gravity of GAB 28A causes the stabilizing platform to become partially submerged as shown in FIG. 66. This force locates sheave 211 and slings 209 above the GAB center of gravity, which orients GAB 28A horizontally (parallel to the ocean floor) even if it was partially inclined during free-sinking.

Position V (FIG. 66) shows that the GAB has reached the ocean floor with the stabilizing platform almost fully submerged, leaving only winch platform 121 above the ocean surface.

Position VI (FIG. 66) shows stabilizing platform 115 returned to the ocean surface, which is achieved by gradually releasing hoisting line 125 from winch 123.

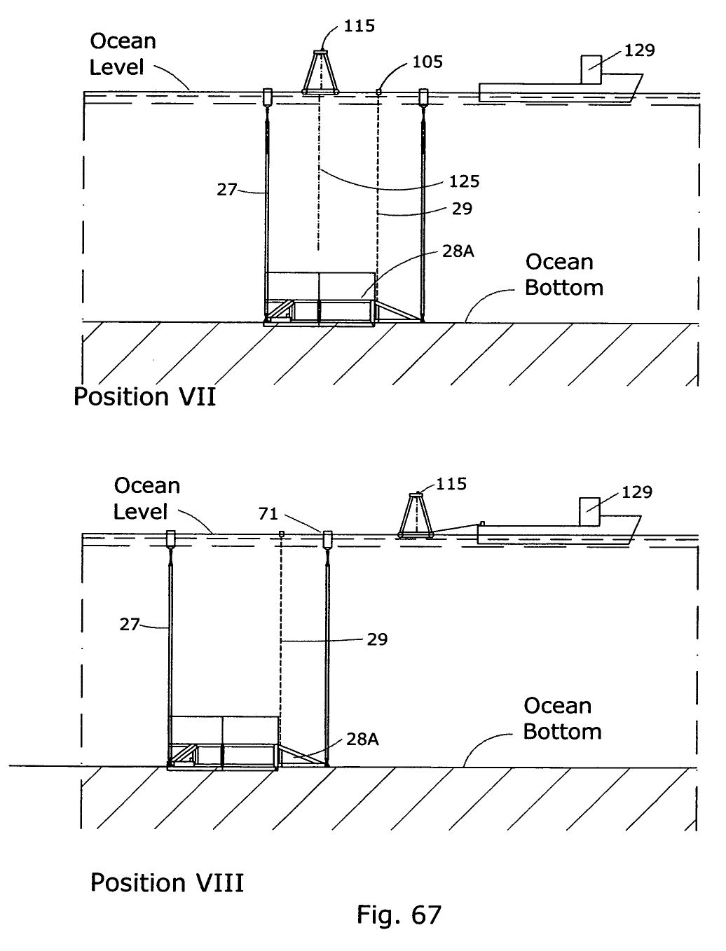

Position VII (FIG. 67) shows one end of hoisting line 125 detached from quick release device 127 (FIG. 24) and the process of winding the remaining length of hoisting line 125 onto winch 123.

Position VIII (FIG. 67) shows the fully installed GAB with buoys 71 and 105, tensioned tethers 27 and power cable 29 while stabilizing platform 115 is being towed away by tug 129.

What is claimed is:

1: A deepwater windpower plant (DWP) having a typical offshore wind turbine mounted by its tower to the top of a floating tension leg floating platform and having means for connecting it to a gravity anchoring base on the ocean floor, comprising:
a means for near-shore assembling said DWP in a vertical position by placing said typical offshore wind turbine on the said floating tension leg platform at a high-rise crane station,
a DWP Installer for transporting said DWP in a vertical position to the installation site in deep waters,
said means for connecting said floating platform with said gravity anchoring base comprising an unequal number of at least three tethers with multiple wire ropes,
a gravity anchoring base (GAB) in a form of floatable vessel with a stabilizing platform controlling its descent and landing on the ocean floor, and
means for an automated engagement of said floating platform with said gravity anchoring base through said three tethers.

2: A DWP according to claim 1, wherein said means for near-shore assembling said DWP comprises:
a floating platform containing:
a pontoon, with three outreach levers,
a set of at least three tether catchers attached to ends of said three outreach levers in a similar orientation, each of said tether catchers including first and second guiding bars attached to a cone receptor which has an open slot for said tether to enter,
a boarding platform attached to said wind turbine tower,
at least three legs connecting said pontoon with said boarding platform,
means for sinking and refloating said floating platform including a compressed air system and a remote-controlled valve on the bottom of said pontoon; and
a high-rise crane station comprising:
a crane,
a pedestal supporting said crane,
a pier on which said pedestal is installed, and
underwater supports for temporary placement of said floating base.

3: A DWP according to claim 1, wherein the DWP installer comprises:
a catamaran-type barge that includes:
at least two pontoons interconnected by a barge cross-connecting structure, which includes a support tower and upper and lower service platforms,
machinery rooms containing a diesel generator, an air compressor and a hydraulic power pack,
the support tower including upper and lower engaging guides, which provide to said DWP tower the possibility of free vertical movement and restrict its inclination due to a large waterplane area of said two pontoons,
each of the engaging guides including:
three rollers equally located along the diameter of said DWP tower, one of them being fixed and the others being side rollers and pivotal,
each of said pivotal rollers being attached to one end of a two-arm lever, a second end of the two-arm lever being connected to a hydraulic cylinder adapted to move the side roller into contact or out of contact with said DWP tower.

4: A DWP according to claim 1, wherein the number of tethers is at least three and the tethers are attached by their upper part to said outreach levers of said floating pontoon through a centering cone and through anchors on their lower part to the ends of outreach levers of said gravity anchoring base,
each of said tethers comprising:
an upper part and a lower part which are interconnected by two pairs of wire ropes in the form of a loop,
said upper part of said tether mounting the centering cone to which an upper rod and an upper wire rope receiver, having a half-circle form, are attached through a chain link connector,
said lower part of said tether including the anchor, which at its lower end is engaged with the gravity anchoring base and at its upper end is connected to a rod with a lower wire rope receiver through a chain link connector.

5: A DWP according to claim 1, wherein the gravity anchoring base (GAB) is in the form of a floatable vessel and with means stabilizing its descent and landing on the ocean floor, comprising:
a box with an open top having: a floor, walls, a central post, three diagonal girders with three ropes forming lifting slings with one sheave, and a valve for controlling said box flooding,
a power cable connector,
three outreach levers,
soil knifes, and
a stabilizing platform for controlling GAB descent and landing flat on the ocean floor comprising a pontoon, a winch platform, four legs, a winch, a hoisting line and a device for quick-disconnecting said hoisting line.

6: A deepwater windpower plant (DWP) for installation on the ocean surface comprising a floating platform including an evacuable base at its lower end adapted to hold variable amounts of water and air for adjusting a buoyancy of the platform; a wind generator mounted on an upright post carried by the platform; first, second and third outreach arms projecting in a generally horizontal direction from the base, each arm including a tether connector proximate its free end; a gravity anchoring base (GAB) defining an upwardly open container formed by a floor and upwardly extending walls surrounding the floor, the container holding a ballast material dropped into the container; and first, second and third tethers secured to the GAB, extending upwardly therefrom, and engaging the tether connectors at the free ends of the outreach arms, the tethers having a length so that the base of the floating platform is substantially fully submerged beneath the ocean surface when the tethers are secured to the connectors of the outreach arms.

7: A DWP according to claim 6 including a floating DWP installer for transporting the DWP from a location close to shore to a desired destination on the ocean surface comprising first and second, spaced-apart pontoons, a cross-structure connecting the pontoons, and an engagement mechanism configured for releasably attaching the DWP installer to the upright post of the DWP carried by the floating platform.

8: A DWP according to claim 6 wherein the ballast material has been dropped into the upwardly open container from a vessel floating on the ocean surface above the container.

9: A DWP according to claim 7, wherein the DWP installer comprises
a catamaran-type barge including
first and second pontoons interconnected by a cross-connecting structure, which includes a support tower and upper and lower service platforms,
machinery rooms housing at least one of a diesel generator, an air compressor and a hydraulic power pack, and
upper and lower clamps releasably connecting the upright post of the platform to the DWP support tower permitting at least some relative vertical movement of the upright post and restricting inclination of the upright post due to a large waterplane area defined by the pontoons,
each of the engaging clamps including
at least three rollers substantially equally located about a diameter of the DWP support post, one of the rollers being fixedly mounted on the support tower and the other rollers being pivotally mounted on the support tower,
each of the pivotally mounted rollers being attached to one of two arms of the lever, the other end of the two arms of the lever being connected to a hydraulic cylinder adapted to move the other two rollers into and out of contact with the DWP post.

10: A DWP according to claim 6, wherein the GAB comprises a box with an open top having
a floor, walls, a central post, three diagonal girders with tree ropes forming lifting slings with one sheave, a power cable connector, three outreach levers and soil knives.

11: A deepwater windpower plant (DWP) having a typical offshore wind turbine mounted by its tower on a top of a floating tension leg floating platform and having means for connecting the floating tension leg platform to a gravity anchoring base (GAB) on the ocean floor, comprising
a device for assembling the DWP close to shore in a vertical position by placing the typical offshore wind turbine onto the floating tension leg platform,
a DWP installer for transporting the DWP while in an upright position to an installation site in deep ocean waters,
at least three tethers each defined by a plurality of wire ropes for connecting the floating platform to the GAB,
transporting the GAB to the installation site and there sinking the GAB to the ocean floor and loading the GAB with ballast material,
couplers configured to automatically engage the floating platform with the at least three tethers to the GAB, and
an electrical power cable having an upper end attached to the floating platform and a lower end attached to the GAB.

12: A DWP according to claim 11, wherein the floating platform comprises
a base with at least three outreach arms,
at least three tether catchers which are part of the couplers and are attached to ends of the outreach arms, each of the tether catchers having two guiding bars attached to a cone receptor which has an open slot for the tether to enter,
a boarding platform connected to a tower of the wind turbine,
legs connecting the base to the boarding platform, and
an evacuable space formed by the base and configured to receive and release at least one of air and water into and from the space with a remote-controlled valve disposed on a lower side of the space for sinking and refloating the floating platform.

13: A method of installing a deepwater windpower plant (DWP) on the ocean surface remote from shore comprising
assembling a floating platform including a hollow, evacuable base, outreach arms laterally extending from the base, an upright post extending upwardly from the base, and a wind turbine installed on the upright post at a location close to shore while the platform is supported in the water,
providing an upwardly open container defined by a floor and walls extending upwardly from the floor to define an open top for the container,
towing the container through the water to a point of installation on the ocean,
sinking the container at the point of destination so that the container lies substantially flat on the ocean floor,
dropping ballast material through the open top into the container to increase a weight of the container,
attaching buoys to free ends of the tether lines,
floating at least three spaced-apart tether lines with the buoys from the container to the ocean surface,
towing the DWP including its floating platform to the destination site,
vertically aligning the DWP with the open container on the ocean floor so that the open container and the DWP are in substantial vertical alignment with each other,
engaging the free ends of the floating tethers with the laterally extending outreach arms of the floating platform to thereby secure the DWP and the floating platform to the open container so that the open container, and the ballast therein, form a gravity anchor for the platform and the DWP,
adjusting the relative height of the DWP and the associated floating platform relative to the open container so that the hollow base of the floating platform is proximate the ocean surface, and
collecting electric energy generated by the DWP caused by ocean winds passing the DWP.

14: A method according to claim 13 including adjusting a buoyancy of the base of the DWP so that the base is submerged beneath the ocean surface.

15: A method according to claim 13 wherein adjusting comprises selectively filling the evacuable base with at least one of air or water to adjust the buoyancy of the platform and therewith adjust tension forces applied by the DWP including its base to the tethers secured to the container.

16: A method according to claim 13 wherein dropping ballast material comprises placing the ballast material into the open container while the open container is afloat.

17: A method according to claim 13 wherein dropping ballast material comprises gravitationally dropping the material from the ocean surface into the open container while the open container rests on the ocean floor.

18: A method according to claim 13 wherein towing the container to and sinking it at the point of installation comprises
at the installation site opening a valve of the container with an open top for flooding the container with water to thus start submerging the container in the ocean water,
after the container is submerged below the ocean surface, pulling the tethers and the power cable with buoys to the ocean surface,
continuing sinking the container until the platform is placed above the center of gravity of the container,
when the container is about 10 meters above the ocean floor, further sinking the container with the platform to partially submerge the platform and create an additional buoyancy force, which acting through said hoisting line and said sling arrangement positions the center of gravity of the container substantially precisely under the hoisting line while orienting the container in a horizontal position,
after the container rests on the ocean floor, releasing the one end of the hoisting line so that, thereafter, the platform is held in the desired position above the GAB, and
thereafter towing the platform away.

19: A method according to claim 18, wherein the tethers are each formed by multiple wire ropes attached by their upper part to the outreach arms of the platform through a centering cone and associated anchors on the lower parts to ends of outreach levers of the GAB, and wherein the upper part and the lower part of each of the tethers are interconnected by first and second pairs of wire ropes defined by wire rope loops,
wherein the upper part of the tether has a centering cone to which an upper rod and upper substantially semicircular wire rope receivers are attached with a chain link connector, and
wherein the lower part of the tether has an anchor which at its lower end is secured to the GAB.

20: A method according to claim 18, including automatically engaging the platform with the tethers comprising
sinking the DWP before approaching the pre-positioned tethers to a level at which the set of tether catchers are positioned at substantially the same level as a middle of a tether rod connecting a centering cone with an upper wire rope receiver,
continuing the horizontal movement of the platform until the set of tether catchers of the platform substantially simultaneously contacts the tether rods and guides them into open slots defined by the cone receptor,
after all rods of the tethers are positioned in the openings of the cone receptors of the tether catchers, permitting the platform to float up and by this bringing the cone opening of the tether catchers into contact with the tether centering cone, and
removing water from the evacuable space of the platform to increase the buoyancy of the platform and thereby pretension the tethers to a desired level.
